(19) United States
(12) Patent Application Publication
(10) Pub. No.: US 2026/0166720 A1
(43) Pub. Date: Jun. 18, 2026

(54) STATORLESS GEARHEAD MOTOR

(71) Applicant: 4D Surgical, Inc., Salt Lake City, UT (US)

(72) Inventors: Lorne Wyatt Hofstetter, Salt Lake City, UT (US); Blake Edwin Zimmerman, Salt Lake City, UT (US); Casey James Nordgran, Grantsville, UT (US); Troy Keiser Arbuckle, Bountiful, UT (US); Ian Coll McEachern, San Francisco, CA (US)

(21) Appl. No.: 19/390,077

(22) Filed: Nov. 14, 2025

Related U.S. Application Data
(60) Provisional application No. 63/721,025, filed on Nov. 15, 2024.
(60) Provisional application No. 63/840,838, filed on Jul. 9, 2025.

(51) Int. Cl. H02K 1/26; B25J 9/12; F16H 49/00; H02K 7/102; H02K 7/116; H02K 11/01; H02K 11/22; H02K 13/00

(52) U.S. Cl. CPC B25J 9/126; F16H 49/001; H02K 1/26; H02K 7/116; H02K 11/22; H02K 13/003; H02K 7/102; H02K 11/012; H02K 2211/03

(57) ABSTRACT

A statorless gearhead motor includes: a rotor and including coil windings that generate magnetic dipoles that interact with a magnetic field generated by an MRI machine to rotate the rotor about a rotor axis; a slip-ring assembly coaxial with the rotor axis and electrically coupling the set of coil windings to a motor driver; a power transmission coupled to the rotor; a non-conductive driveshaft coupled to the power transmission and configured to output torque a) generated by the set of coil windings interacting with the magnetic field of the MRI and b) transmitted from the rotor to the non-conductive driveshaft by the power transmission; and a non-ferrous shield arranged about the set of hollow-core coil windings and configured to attenuate propagation of electromagnetic fields, generated by the set of hollow-core coil windings, toward the MRI.

### CROSS-REFERENCE TO RELATED APPLICATIONS

This Application claims the benefit of U.S. Provisional Application No. 63/840,838, filed on 09 Jul. 2025, and 63/721,025, filed on 15 Nov. 2024, each of which is hereby incorporated in its entirety by this reference.

### TECHNICAL FIELD

This invention relates generally to the field of surgical robotics and, more specifically, to a new and useful drive unit in the field of surgical robotics.

### BRIEF DESCRIPTION OF THE FIGURES

FIG. 1 is a schematic representation of a drive unit;

FIG. 2 is a schematic representation of one variation of the drive unit;

FIG. 3 is a schematic representation of one variation of the drive unit;

FIGS. 4A and 4B are schematic representations of one variation of the drive unit;

FIGS. 5A, 5B, and 5C are schematic representations of a robotic arm integrating one variation of the drive unit; and

FIG. 6 is a schematic representation of one variation of the drive unit.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Drive Unit

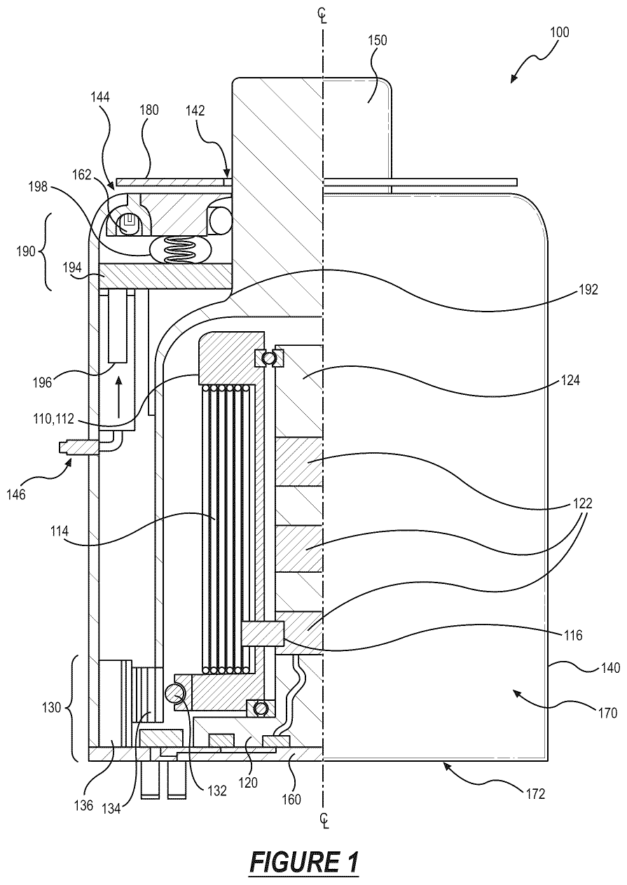

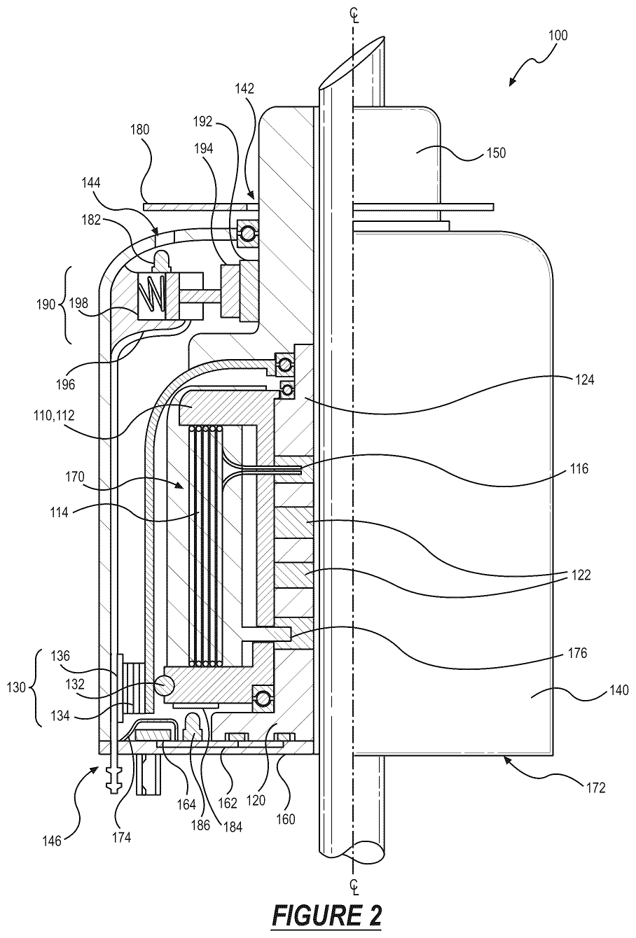

As shown in FIGS. 1 and 2, a drive unit 100 is configured to integrate into a surgical robotic system (e.g., a robotic arm 200) arranged proximal (e.g., within) an intraoperative imaging suite (e.g., a magnetic resonance imaging machine).

The drive unit 100 includes: a shielded enclosure; an actuator (e.g., piezoelectric actuator, electromagnetic actuator); and a non-conductive driveshaft 150.

The shielded enclosure includes: a housing 140; and a first electromagnetic shield 170. The housing 140: contains the actuator; and defines a driveshaft aperture 142. The first electromagnetic shield 170 defines (or “forms”) a Faraday cage that envelops the actuator and attenuates propagation of an electromagnetic field—generated by the actuator during operation—beyond the shielded enclosure.

The actuator (e.g., a piezoelectric actuator, an electromagnetic actuator) is located within the shielded enclosure

The non-conductive driveshaft 150: is coupled to and is driven (i.e., rotated) by the actuator; extends through the driveshaft aperture 142 of the shielded enclosure; and includes a non-conductive material (e.g., Delrin, Garolite) that attenuates transmission of electromagnetic signals—generated by the actuator—beyond the shielded enclosure.

When actuated, the actuator: generates an electromagnetic field that interacts with a magnetic field generated by the intraoperative imaging suite, which induces rotation of the actuator, which rotates the non-conductive driveshaft 150. The shielded enclosure cooperates with the non-conductive driveshaft 150 to contain this electromagnetic field within the shielded enclosure, to attenuate propagation of radio frequency signals beyond the shielded enclosure, and to thus isolate electromagnetic noise generated by the drive unit 100 from the intraoperative imaging suite.

### 1.1 Geartrain+Conductive Rotor Shaft

In one variation, the actuator includes: a conductive (e.g., metal) rotor shaft defining a first diameter less than a second diameter of the non-conductive driveshaft 150 and configured to output a torque generated by the actuator; and a set of coil windings 114 supported on the conductive rotor shaft and configured to generate electromagnetic fields that interact with the magnetic field generated by the intraoperative imaging suite to induce rotation of the conductive rotor shaft.

In this variation, the drive unit 100 further includes a geartrain: arranged within the housing 140; that couples and transfers torque between the conductive rotor shaft and the non-conductive driveshaft 150 (e.g., via a set of non-conductive gears or timing belts); and that is configured to step-down a speed of the conductive rotor shaft and to step-up a torque transmitted from the conductive rotor shaft into the non-conductive driveshaft 150.

In this variation, the conductive rotor shaft can form an antenna that broadcasts an electromagnetic field (e.g., radio-frequency noise). Accordingly, the shielded enclosure can attenuate propagation of this electromagnetic field generated by the conductive rotor shaft beyond the shielded enclosure, thereby isolating this electromagnetic field (e.g., radio-frequency noise), generated by the drive unit 100, from the intraoperative imaging suite.

### 1.2 Brake

In another variation shown in FIGS. 1 and 2, the drive unit 100 further includes a brake: arranged within the shielded enclosure; and configured to selectively brake (e.g., lock and unlock) the non-conductive driveshaft 150 against the shielded enclosure.

In this variation, the brake 190 includes: a friction disk 192 coupled to the non-conductive driveshaft 150; a first pressure plate 194 arranged within the shielded enclosure, coupled to the shielded enclosure, and facing the friction disk 192; and a second pressure plate arranged within the shielded enclosure, coupled to the shielded enclosure, facing the first pressure plate 194 opposite the first pressure plate 194, and operable in a braked position and a released position.

The brake 190 further includes: a spring 198 configured to bias the second pressure plate toward the braked position, thereby impinging the friction disk 192 between the first pressure plate 194 and the second pressure plate and locking the non-conductive driveshaft 150 against the shielded enclosure; and a brake actuator (e.g., a piezoelectric, hydraulic, or pneumatic element) configured to selectively drive the second pressure plate against the spring 198 to release the friction disk 192 from the first pressure plate 194 and the second pressure plate, thereby releasing the non-conductive driveshaft 150 to rotate relative to the shielded enclosure.

### 1.3 Controller+Wiring

In one variation shown in FIGS. 1 and 2, the drive unit 100 includes: a driveshaft encoder arranged inside the shielded enclosure and coupled to the non-conductive driveshaft 150; a motor driver 164 arranged within the shielded enclosure and configured to supply data and power signals to the encoder and the actuator; and electrical cabling passing through the shielded enclosure and coupling an external controller (e.g., motor controller) to the motor driver 164.

For example, the electrical cabling can define three-wire cabling to supply ground, power, and data signals from the external controller to the motor driver 164. Alternatively, the electrical cabling can define two-wire cabling to supply ground and power signals from the external controller to the motor driver 164. In this example, data signals are transmitted as an alternating current signal over a direct current power signal.

The external controller is configured to (e.g., via I2c communication protocol): receive a target angular position or a target angular speed of the non-conductive driveshaft 150, such as from an operator interfacing with a surgical robotic system; read encoder signals from the encoder coupled to the non-conductive driveshaft 150; and implement closed-loop controls to drive the actuator to achieve rotation of the non-conductive driveshaft 150 according to the target angular position or the target angular speed based on position signals output by the encoder.

### 2. Statorless Gearhead Motor

In one variation shown in FIGS. 1 and 2, the drive unit 100 defines a statorless gearhead motor including: a rotor 110; a slip-ring assembly 120; a power transmission 130 coupled to the rotor 110; a non-conductive driveshaft 150; and a non-ferrous shield.

The rotor 110: is configured to rotate about a rotor axis; and includes a set of coil windings 114 configured to generate magnetic dipoles that interact with a magnetic field generated by a magnetic resonance imaging machine to rotate the rotor 110 about the rotor axis.

The slip-ring assembly 120: is coaxial with the rotor axis; and is configured to electrically couple to the set of coil windings 114.

The power transmission 130 is coupled to the rotor 110.

The non-conductive driveshaft 150: is coupled to the power transmission 130; and is configured to output torque generated by the set of coil windings 114 interacting with the magnetic field generated by the magnetic resonance imaging machine and transmitted from the rotor 110 to the non-conductive driveshaft 150 by the power transmission 130.

The non-ferrous shield: is arranged about the set of hollow-core coil windings 114; and is configured to attenuate propagation of electromagnetic fields, generated by the set of hollow-core coil windings 114, toward the magnetic resonance imaging machine.

### 2.2 Variation: Driveshaftless Statorless Gearhead Motor

In one variation, the power transmission 130: is coupled to the rotor 110; and is configured to output torque generated by the set of coil windings 114 interacting with the magnetic field generated by the magnetic resonance imaging machine and transmitted from the rotor 110 into the power transmission 130.

### 2.3 Variation: Internal Slip-ring Assembly

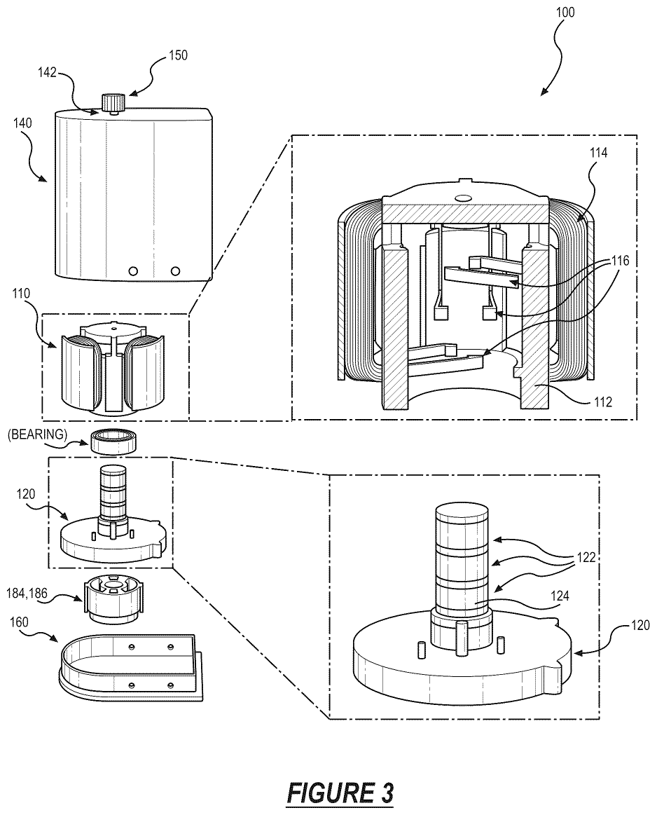

In one variation shown in FIGS. 1, 2, and 3, the rotor 110: is configured to rotate about a rotor axis; and includes a set of coil windings 114 configured to generate magnetic dipoles that interact with a magnetic field generated by a magnetic resonance imaging machine to rotate the rotor 110 about the rotor axis.

The slip-ring assembly 120: is coaxial with the rotor axis; extends into a center of the rotor 110; and includes a set of slip-rings 122 configured to electrically couple to the set of coil windings 114.

The power transmission 130 is coupled to the rotor 110.

The housing 140: contains the rotor 110, the slip-ring assembly 120, and the power transmission 130; and defines a driveshaft aperture 142.

The non-conductive driveshaft 150: is coupled to the power transmission 130; extends through the driveshaft aperture 142 of the housing 140; and is configured to output torque generated by the set of coil windings 114 interacting with the magnetic field generated by the magnetic resonance imaging machine and transmitted from the rotor 110 to the non-conductive driveshaft 150 by the power transmission 130.

### 2.4 Variation: Strain-Wave Power Transmission

In another variation shown in FIGS. 1, 2, 4A, and 4B, the rotor 110: is configured to rotate about a rotor axis; includes a set of hollow-core coil windings 114 configured to generate magnetic dipoles that interact with a magnetic field generated by a magnetic resonance imaging machine to rotate the rotor 110 about the rotor axis; and includes a set of rotor contacts 116 electrically coupled to the set of hollow-core coil windings 114 and extending toward the rotor axis.

The slip-ring assembly 120: is coaxial with the rotor axis; is arranged within the rotor 110; and includes a set of slip-rings 122 configured to electrically couple to the set of rotor contacts 116.

The strain-wave transmission 130 includes: a wave-generator bearing 132 coupled to the rotor 110 and laterally adjacent the set of hollow-core coil windings 114; a flexspline cup 134 arranged about the wave-generator bearing 132 and configured to rotate about the rotor axis; and a circular-spline ring 136 arranged about the flexspline cup 134 and coaxial with the rotor 110.

The housing 140: contains the rotor 110, the slip-ring assembly 120, the wave-generator bearing 132, and the flexspline cup 134; and defines a driveshaft aperture 142.

The non-conductive driveshaft 150: is coupled to the strain-wave transmission 130; extends through the driveshaft aperture 142 of the housing 140; and is configured to output torque a) generated by the set of hollow-core coil windings 114 interacting with the magnetic field generated by the magnetic resonance imaging machine and b) transmitted from the rotor 110 to the non-conductive driveshaft 150 by the strain-wave transmission 130.

### 3. Applications

Generally, a drive unit 100: defines a statorless gearhead motor configured to actuate joints or other elements within a surgical robotic system (e.g., a robotic arm 200) operating within an intraoperative imaging suite (e.g., a magnetic resonance imaging, or “MRI,” machine); and includes specific classes of non-ferrous, non-conductive, and non-magnetic components in a particular arrangement to limit degradation of imaging quality of the intraoperative imaging suite in order to enable concurrent surgical operations and imaging within the intraoperative imaging suite, such as imaging-assisted neurosurgery.

In particular, in order to limit imaging quality degradation of the intraoperative imaging suite resulting from presence and/or operation of the drive unit 100 within the intraoperative imaging suite (given the output torque rating of the drive unit 100), the drive unit 100 can include: a first electromagnetic shield 170 that attenuates electromagnetic radiation generated by coil windings 114, encoders, a motor driver 164, wiring, and other electrical components within the drive unit 100; perforations in the first electromagnetic shield 170 that interrupt Eddy-current loops that may otherwise distort the magnetic field generated by the intraoperative imaging suite and/or induce emission of secondary electromagnetic radiation; and a non-conductive (e.g., polymer) output shaft that—while approximating the geometry of an antenna—reradiates relatively little or no radio-frequency noise generated within the housing 140 due to operation of the statorless gearhead motor and/or due to the magnetic field generated by the intraoperative imaging suite.

Furthermore, the drive unit 100 includes limited volumes of ferrous, conductive, and magnetic materials (given the output torque rating of the drive unit 100) in order to limit distortion of images generated by the intraoperative imaging suite. In particular, the drive unit 100 can exclude a stator (e.g., permanent magnets) and can instead leverage the magnetic field generated by the intraoperative imaging suite for the stator field with which coil windings 114 in the drive unit 100 interact in order to rotate the rotor 110, the power transmission 130, and the non-conductive driveshaft 150. The drive unit 100 can also include: hollow-core coil windings 114 arranged on the rotor 110; and slip-rings 122 with non-magnetic, smooth contacts that communicate current to these hollow-core coil windings 114, thereby eliminating a traditional commutator and brush assembly that may arc, exhibit inductive heating, and emit radio-frequency noise in the presence of the magnetic field of the intraoperative imaging suite.

Iron or conductive coil winding cores may both: generate Eddy currents that oppose and distort intended magnetic fields of the intraoperative imaging suite; exhibit inductive heating in the presence of the magnetic field generated by the intraoperative imaging suite. Therefore, exclusion of such cores may reduce distortion of images generated by the intraoperative imaging suite and eliminate a source of heat within the drive unit 100 during operation, thereby: reducing cogging and smoothing a torque output profile of the statorless gearhead motor; and enabling incorporation of less thermally-resilient or stable materials—that also produce less distortion of and interaction with the magnetic field generated by the intraoperative imaging suite—within the drive unit 100, such as one or more polymers that form the non-conductive driveshaft 150, the housing 140, a rotor hub 112, a column 124 of the slip-ring assembly 120, and/or elements of the power transmission 130.

Furthermore, the drive unit 100 can eliminate elements (e.g., a traditional rotor shaft), nest elements (e.g., a slip-ring assembly 120, rotor 110, and gearbox), and/or consolidate traditionally distinct elements (e.g., a housing 140 and a circular-spline ring 136 of a strain-wave gearbox; a drive unit 100 base 160 and a motor driver 164) in order to: reduce total mass and volume of the drive unit 100 (for the output torque rating of the drive unit 100), thereby reducing torque rating and braking requirements of other drive units 100 within the robotic arm 200; and reduce the volume of the drive unit 100, thereby reducing the surface area of the housing 140, reducing the surface area and total mass of the first electromagnetic shield 170, and thus reducing a vector for Eddy-current generation and electromagnetic noise transmission within the drive unit 100.

### 3.1 Example: Strain-Wave Transmission With Integral Housing and Shield

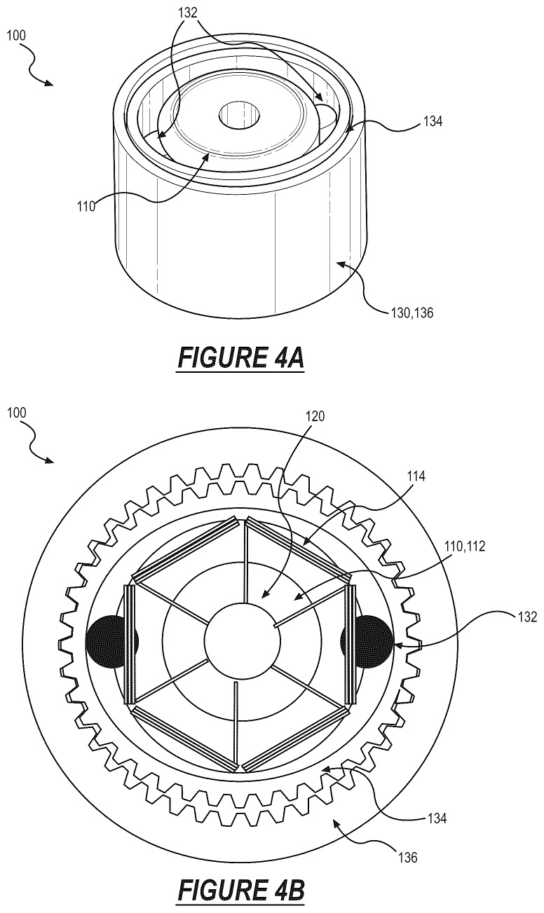

In one example shown in FIGS. 4A and 4B, the slip-ring assembly 120 includes a column 124 (e.g., a polymer “post”) supporting a set of slip-rings 122. The rotor 110 includes: a polymer rotor hub 112 supported on the column 124 of the slip-ring assembly 120, such as by a pair of ceramic ball bearings or bushings; and a set of (e.g., three, six) non-ferrous (e.g., copper) coil windings 114 radially arranged about and mounted to the rotor hub 112.

In this example, the power transmission 130 defines a strain-wave transmission 130 including: a wave-generator bearing 132; a flexspline cup 134; and a circular-spline ring 136. The wave-generator includes an elliptical plug arranged on, integrated into, or physically coextensive with (i.e., of the same, continuous material) the rotor hub 112 of the rotor 110 and adjacent the set of coil windings 114. For example, the elliptical plug can include a set of bearings or a bearing surface encircling or extending outwardly between the set of coil windings 114.

In this example, the flexspline cup 134: defines a bellform (or “bell-shaped”) geometry; is arranged about the wave-generator bearing 132; is configured to rotate about the rotor axis; includes a set of external gear teeth; is configured to elastically deform into a rotating elliptical cross-section that follows the wave-generator bearing 132; encapsulates the sides and tops of the wave-generator bearing 132, the rotor 110, and the slip-ring assembly 120; and is directly coupled (e.g., fastened, bonded) to the non-conductive driveshaft 150, which passes through and is supported by a bearing or journal in the driveshaft aperture 142 in the housing 140.

The circular-spline ring 136: defines a bellform geometry nested over the flexspline cup 134; is arranged about the flexspline cup 134 and coaxial with the rotor 110; defines a set of internal gear teeth configured to mesh with the external gear teeth of the flexspline cup 134; and forms the housing 140 that defines the driveshaft aperture 142 and encapsulates the sides and tops of the flexspline cup 134, the wave-generator bearing 132, the rotor 110, and the slip-ring assembly 120.

In this example, the first electromagnetic shield 170 (e.g., a copper-alloy mesh) is applied (e.g., bonded, plated, sputtered, and/or etched) directly to the outer surface of the circular-spline ring 136.

In this example, the drive unit 100 further includes a base 160 formed by a printed circuit board (or “PCB”): that rigidly couples the slip-ring assembly 120 to the circular-spline ring 136, such as via a solder joint and threaded fasteners, respectively; supports a motor driver 164; includes a set of traces 162 that electrically couple the motor driver 164 to the slip-ring assembly 120; and includes a conductive trace layer extending across the (outer) surface of base 160 to form a second electromagnetic shield 172 electrically coupled to the first electromagnetic shield 170 arranged on the circular-spline ring 136. These first electromagnetic shields 170 on the circular-spline ring 136 and the base 160 can thus form a continuous return path and/or a common reference potential that suppression transmission of electromagnetic noise from the drive unit 100.

Thus, in this implementation, the slip-ring assembly 120, the rotor 110 and wave-generator bearing 132 assembly, and the flexspline cup 134 are coaxial and nested within the circular-spline ring 136, which also functions as the housing 140. The base 160 encloses the slip-ring assembly 120, the rotor 110 and wave-generator bearing 132 assembly, and the flexspline cup 134 within the circular-spline ring 136 and functions to locate the slip-ring assembly 120 relative to the circular-spline ring 136, to communicate electrical signals from the motor driver 164 to the slip-ring assembly 120, and to complete the first electromagnetic shield 170 around the drive unit 100.

Thus, in this example, the drive unit 100 can exclude distinct housing 140 and rotor shaft components, and other components can perform multiple functions traditionally allocated to discrete components, thereby reducing electromagnetic footprint, mass, and volume of the drive unit 100 for a given torque rating of the drive unit 100.

### 3.2 Surgical Robotic Arm and Image-assisted Surgery

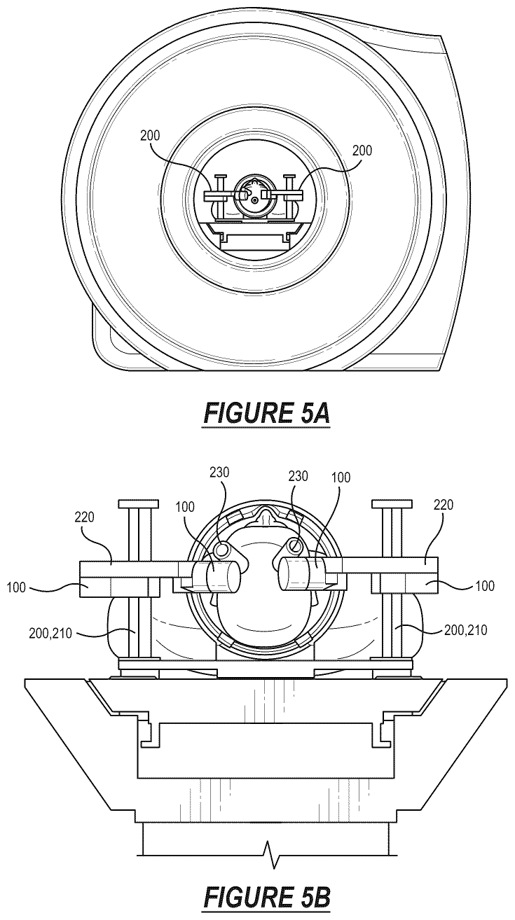

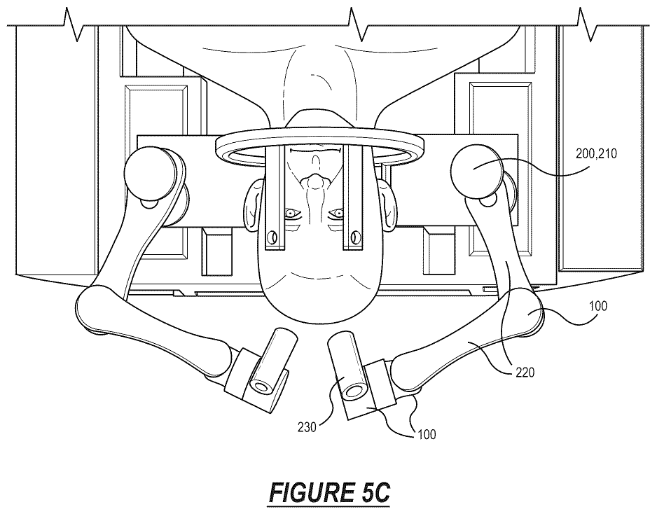

As shown in FIGS. 5A, 5B, and 5C, multiple similar or identical drive units 100 can be combined with a robotic arm base 210, a set of robotic arm segments 220, and an end effector 230 to form a multi-joint surgical robotic arm 200. In particular, the robotic arm 200 can include one instance of the drive unit 100: in the robotic arm base 210 of the multi-joint surgical robotic arm 200; at each arm joint of the multi-joint surgical robotic arm 200; and in the end effector 230.

Because the drive unit 100 is configured to yield limited electromagnetic noise and includes minimal conductive, metallic, and/or ferrous material, the multi-joint surgical robotic arm 200 may be operated within a primary (e.g., B₀) magnetic field generated by the intraoperative imaging suite—such as to perform live, imaging-assisted neurosurgery actions on a patient within the intraoperative imaging suite—while the intraoperative imaging suite captures live (brain) scans of the patient, which may be served to a surgeon remotely-controlling the multi-joint surgical robotic arm 200, such as within or outside of the intraoperative imaging suite.

Furthermore, multiple similar or identical surgical robotic arms 200 can be arranged within the intraoperative imaging suite, such as on each side of a sagittal plane of the table in the intraoperative imaging suite near and near a head of the table.

### 3.3 Disclaimers

Generally, the drive unit 100 is described herein as a statorless gearhead motor: that includes a strain-wave transmission 130; in which a housing 140 of the drive unit 100 and a circular-spline ring 136 of the strain-wave transmission 130 form a unitary structure or are otherwise physically coextensive; in which a rotor 110 (e.g., the rotor hub 112 and coil windings 114; an armature) and a slip-ring assembly 120 are nested inside of—rather than in line with—the strain-wave transmission 130; in which a separate base 160 (e.g., a printed circuit board) functions to both mechanically couple the circular-spline ring 136 to the slip-ring assembly 120 and electrically couple a motor driver 164 to the slip-ring assembly 120; and in which the housing 140, the circular-spline ring 136, and the base 160 cooperate to physically enclose and electromagnetically shield the rotor 110, slip-ring assembly 120, and motor driver 164.

However, the housing 140 of the drive unit 100 and the circular-spline ring 136 of the strain-wave transmission 130 can define separate structures, such as with the former containing the latter. Additionally or alternatively, the drive unit 100 can include other types or forms of coaxial or non-axial power transmissions 130 or unnested rotor 110 and power transmission 130 assemblies.

Furthermore, the drive unit 100 is described here in as incorporating a rotor 110 and coil windings 114 that form a DC or AC, single- or multi-phase electromagnetic motor. However, the drive unit 100 can alternatively include a piezoelectric actuator-in place of the rotor 110 and coil windings 114—that functions to rotate the wave-generator bearing 132.

### 4. Rotor and Slip-ring Assembly

As shown in FIGS. 1 and 2, the drive unit 100 includes a rotor 110 and a slip-ring assembly 120. The rotor 110: is configured to rotate about a rotor axis; includes a set of hollow-core coil windings 114 configured to generate magnetic dipoles that interact with a magnetic field generated by a magnetic resonance imaging machine to rotate the rotor 110 about the rotor axis; and includes a set of rotor contacts 116 electrically coupled to the set of hollow-core coil windings 114 and extending toward the rotor axis. The slip-ring assembly 120: is coaxial with the rotor axis; is arranged within the rotor 110; and includes a set of slip-rings 122 configured to electrically couple to the set of rotor contacts 116.

In particular, the slip-ring assembly 120 includes a set of discrete slip-rings 122 coupled to a motor driver 164. The rotor 110 includes: a rotor hub 112; a set of (e.g., three, six) non-ferrous, conductive (e.g., copper or aluminum) coil windings 114 arranged on the rotor hub 112; and a set of rotor contacts 116 (or “brushes,” conductive tabs), each extending from a coil winding to a corresponding slip-ring 122 to communicate current from the motor driver 164, via the slip-ring 122, into the coil winding, thereby energizing the coil winding. When energized, each coil winding generates a magnetic field that interacts with the static magnetic field of the intraoperative imaging suite (e.g., the Bo field of the magnetic resonance imaging machine) to generate Lorentz forces on the coil winding. These Lorentz forces impart torque on the rotor 110, thereby rotating the rotor 110 about the rotor axis. Therefore, the drive unit 100 can: leverage the magnetic field of the intraoperative imaging suite to rotate the rotor 110 when the coil windings 114 are energized via the slip-rings 122; and exclude a stator, thereby reducing conductive and/or ferrous components that may generate electromagnetic interference when present or manipulated with the intraoperative imaging suite.

### 4.1 Nested Rotor and Slip-ring Assembly

In one implementation shown in FIGS. 1 and 2, the slip-ring assembly 120 is nested within the rotor 110 and defines a (static) column 124 about which rotor 110 rotates. In this implementation, the column 124 can include a rigid polymer post extending upwardly from the base 160 of the drive unit 100, and each slip-ring 122 can include a discrete conductive annular element (e.g., a short, thin-walled copper cylinder) arranged on the column 124. The column 124: is fastened, bonded, or soldered to the base 160; and includes conductors (e.g., wires, tabs) that conduct current between the base 160 on the slip-rings 122 on the column 124. For example, the column 124 can include: a plinth; the column 124 extending upwardly from the plinth; and a set of conductive tabs integrated into the bottom of the plinth and electrically coupled to the slip-rings 122, such as via separate wires extending up the column 124. In this example, the base 160 can include a printed circuit board defining a set of traces soldered to the tabs on the plinth in order to both mechanically retain the plinth to the base 160 and electrically couple the slip-rings 122 to the motor driver 164 located nearby on the printed circuit board.

In this implementation, the rotor 110 can include a hollow rotor hub 112: coupled to the column 124 of the slip-ring assembly 120 by a pair of bearings or bushings (e.g., ceramic ball bearings); configured to rotate about the column 124; and including a set of hollow winding collars defining axes perpendicular to the column 124 and the rotor axis. Conductive non-ferrous (e.g., copper, aluminum) wire: is wound around the winding collars to form the hollow-core coil windings 114; and is terminated at rotor contacts 116 arranged on the rotor hub 112. (These coil windings 114 can also be encapsulated in a polymer resin, such as to prevent movement of the coil windings 114 on the rotor hub 112.) In particular, the rotor 110 includes multiple rotor contacts 116: stacked vertically on the rotor hub 112; and extending inwardly from the rotor hub 112 toward the center of the rotor 110 (i.e., the rotor axis). Each rotor contact 116 is biased against one slip-ring 122 on the column 124 and maintains electrically conductivity with this slip-ring 122 as the rotor 110 rotates about the column 124 of the slip-ring assembly 120. Thus, the slip-ring assembly 120: can be nested inside of the rotor 110; can function as an axle about which the rotor 110 rotates; and can fully support and constrain the rotor 110 in four or five degrees of freedom (e.g., all but rotation about and/or translation along the rotor axis).

In one example, the rotor 110 includes six coil windings 114 arranged on a 60° pitch about the rotor axis with opposing coil windings 114 wired in series to in a star (or “wye”) configuration to form a 3-phase, high-voltage, low-current motor armature. Each pair of opposing coil windings 114 is coupled to one rotor contact 116 that rides on corresponding slip-ring 122 on the column 124. Furthermore, because the opposing coil windings 114 are wired in series, the slip-rings 122 may pass higher voltage but less current into the rotor contacts 116, thereby reducing radio-frequency noise generated by the rotor contacts 116 and the slip-rings 122 and reducing wear therebetween. However, the rotor 110 can include any other quantity of coil windings 114 connected in another way, such as: in parallel; in a delta configuration; in a three-phase with separate returns or a common neutral; in a two-phase configuration; or in a single-phase configuration; etc.

Furthermore, the column 124 (and plinth) of the slip-ring assembly 120 and the rotor hub 112 can each be formed of non-conductive materials, such as polyether ether ketone (or “PEEK”), carbon-fiber-reinforced PEEK (e.g., for increased stiffness), polyphenylene sulfide (or “PPS”), glass-filled PPS, or ceramic (e.g., zirconia or alumina) and such as by injection molding, 3D printing, conventional machining, or sintering.

### 4.2 Unnested Rotor and Slip-ring Assembly

Alternatively, the slip-ring assembly 120 can be located outside of the rotor 110.

In one implementation, the base 160 includes a printed circuit board, and the slip-ring assembly 120 includes a set of concentric traces integrated into the printed circuit board and concentric with the rotor axis. In this implementation, a lower bearing or bushing is fastened, bonded, soldered, or other coupled to the base 160 concentric with the rotor axis. The rotor 110 includes a center rotor shaft supported on its bottom end by the bearing and on its opposing end by a second bearing or bushing located in the top of the flexspline cup 134 and/or the bottom of the non-conductive driveshaft 150. Furthermore, in this implementation, the rotor contacts 116 can extend downwardly—rather than laterally and inwardly—to contact corresponding slip-ring 122 traces on the base 160.

However, the slip-ring assembly 120 and the rotor 110 can be arranged in any other way within the drive unit 100.

### 5. Strain-wave Transmission

As shown in FIGS. 4A and 4B, the strain-wave transmission 130 includes: a wave-generator bearing 132 coupled to the rotor 110 and laterally adjacent the set of hollow-core coil windings 114; a flexspline cup 134 arranged about the wave-generator bearing 132 and configured to rotate about the rotor axis; and a circular-spline ring 136 arranged about the flexspline cup 134 and coaxial with the rotor 110. Generally, the strain-wave transmission 130 functions as a coaxial torque-multiplier and speed reducer that couples the rotor 110 to the non-conductive driveshaft 150. More specifically, the strain-wave transmission 130 defines a compact, non-magnetic, thin-walled flexspline and circular-spline assembly that converts torque generated by the rotor 110 due to interaction between the coil windings 114 and the magnetic field of the intraoperative imaging suite into a reduced-speed, increased-torque output at the non-conductive driveshaft 150.

In particular, the wave-generator bearing 132: forms an elliptical plug defining an elliptical geometry; runs inside of the flexspline cup 134; and is arranged on or integrated into the rotor 110 such that rotation of the rotor 110 drives the elliptical plug against the interior face of the flexspline cup 134, thereby cyclically deforming the flexspline cup 134 into an elliptical cross-section that rotates about the rotor axis at the speed of the rotor 110.

In one implementation, the rotor hub 112 includes a set of (e.g., six) bearing seats: interposed and/or extending between adjacent coil windings 114; and intersecting an elliptical chord. The wave-generator bearing 132 includes a set of non-magnetic (e.g., ceramic, polymer) bearing races located in these bearing seat and configured to run across the inner face of the flexspline cup 134 such that contact patches between these bearing races and the inner face of the flexspline cup 134 intersect an ellipse. Thus, in this implementation, the rotor hub 112 and the bearing seats can define a unitary structure and can cooperate with the bearing races of the wave-generator bearing 132 to form a compact, nested rotor 110 and wave-generator bearing 132 assembly.

The flexspline cup 134: defines a thin-walled, bellform (or flared-cup) geometry arranged about the wave-generator bearing 132; nested over the rotor 110; includes a set of external gear teeth facing opposite the wave-generator bearing 132; elastically deforms into a rotating elliptical geometry within a plane intersecting the external gear teeth under loads applied by the wave-generator bearing 132 as the rotor 110 rotates; is coaxial with and is coupled to or integral with the non-conductive driveshaft 150; and is constrained in four or five degrees of freedom (e.g., all but rotation about and/or translation along the rotor axis) by the wave-generator bearing 132 and the non-conductive driveshaft 150, which is constrained by the driveshaft aperture 142.

The circular-spline ring 136: is nested around the flexspline cup 134; is rigidly coupled to the base 160 and/or the slip-ring assembly 120; defines a stationary member of the strain-wave transmission 130; and includes a set of internal gear teeth configured to mesh with the external gear teeth of the flexspline cup 134. In particular, the circular-spline ring 136 includes two more internal gear teeth than the external gear teeth of the flexspline cup 134 such that cyclical deformation of the flexspline cup 134 into the elliptical cross-section—by rotation of the rotor 110 and the wave-generator bearing 132—causes cyclical meshing of these internal teeth and external teeth to walk the flexspline cup 134 around the circular-spline ring 136 at a rate of two teeth per rotation of the rotor 110 and the wave-generator bearing 132.

For example, the flexspline cup 134 can be formed of a non-magnetic material exhibiting high cycle fatigue, such as: bulk metallic glass; a beta-titanium alloy (e.g., Ti-15-3-3-3 or Ti-6Al-4V ELI); carbon-fiber-reinforced PEEK; carbon-fiber-reinforced PEEK with a titanium-based gear tooth insert; or annealed austenitic stainless 316L. The circular-spline ring 136 can be formed of a stiff, non-magnetic material, such as: a beta-titanium alloy; carbon-fiber-reinforced PEEK; an aluminum-bronze (e.g., in high-load applications, such as in a robotic arm base 210); or a ceramic (e.g., Zirconia).

Thus, the wave-generator bearing 132 can be integrated into the rotor 110 with bearing races nested between coil windings 114, and the flexspline cup 134 and the circular-spline ring 136 can define thin-walled structured nested over rotor 110 and the wave-generator bearing 132 to form a high-torque, low-backlash statorless gearhead motor that is axially and radially compact and contains limited conductive, ferrous, and/or magnetic material.

### 6. Housing

The housing 140 contains the rotor 110, the slip-ring assembly 120, the wave-generator bearing 132, and the flexspline cup 134 and defines a driveshaft aperture 142.

### 6.1 Integrated Housing+Circular-spline Ring

In one implementation shown in FIGS. 1 and 2, the housing 140 and the circular-spline ring 136 are physically coextensive (i.e., a unitary structure formed of a single, contiguous material). In particular, in this implementation, the circular-spline ring 136 defines a bellform (or flared-cup) geometry nested over the flexspline cup 134. A section of the circular-spline ring 136 above the internal gear teeth of the circular-spline ring 136 defines the housing 140 and the driveshaft aperture 142 above the flexspline cup 134 and coaxial with the rotor axis. Thus, the circular-spline ring 136 can: encapsulate the sides and top of the flexspline cup 134, the wave-generator bearing 132, and the rotor 110; define a driveshaft aperture 142 through which the non-conductive driveshaft 150 extends; and support an external first electromagnetic shield 170 (e.g., a bonded or sputtered copper-alloy mesh) that attenuates electromagnetic emissions from within the drive unit 100 and reduces electromagnetic coupling between drive unit 100 and the magnetic field of the intraoperative imaging suite.

For example and as described above, the can include a base 160 (e.g., a printed circuit board) configured to rigidly couple the slip-ring assembly 120 to the circular-spline ring 136. The housing 140 can extend upwardly from the circular-spline ring 136 opposite the base 160, and the circular-spline ring 136 and the housing 140 can cooperate to define a unitary structure that contains the rotor 110, the slip-ring assembly 120, the wave-generator bearing 132, and the flexspline cup 134.

Thus, the unitary housing 140 and circular-spline ring 136 can be formed of: a beta-titanium alloy; carbon-fiber-reinforced PEEK; glass-filled PPS; an aluminum-bronze; or a ceramic (e.g., Zirconia).

### 6.2 Discrete Housing

Alternatively, the housing 140 and the circular-spline ring 136 can define distinct, separate structures. For example, the circular-spline ring 136 can define an annular structure bonded, fastened, or soldered to the base 160 or bonded, fastened, or molded to the housing 140. Accordingly, the housing 140 can cooperate with the base 160 to fully enclose the rotor 110, the slip-ring assembly 120, and the strain-wave transmission 130.

For example, in this implementation, the housing 140 can be formed of a non-conductive material, such as carbon-fiber-reinforced PEEK or glass-filled PPS. The circular-spline ring 136 can be formed of a beta-titanium alloy, an aluminum-bronze, or a ceramic (e.g., Zirconia) and can be fastened to the housing 140, bonded to the housing 140, or overmolded with the housing 140.

### 7. Non-conductive Driveshaft

The non-conductive driveshaft 150: is coupled to the strain-wave transmission 130; extends through the driveshaft aperture 142 of the housing 140; and is configured to output torque a) generated by the set of hollow-core coil windings 114 interacting with the magnetic field generated by the magnetic resonance imaging machine and b) transmitted from the rotor 110 to the non-conductive driveshaft 150 by the strain-wave transmission 130.

In particular, the non-conductive driveshaft 150: is arranged coaxially with the rotor axis; extends through a driveshaft aperture 142 defined by the housing 140; and is configured to transmit torque from the strain-wave transmission 130 to an external linkage or load, such as a joint of a robotic arm 200 operating within the intraoperative imaging suite.

Because the non-conductive driveshaft 150 extends linearly through the housing 140, protrudes from the drive unit 100, and may define an elongated geometry characterized by a relatively high aspect ratio (i.e., length to diameter), the non-conductive driveshaft 150 may approximate a form of a linear antenna and may therefore act as a radio-frequency radiator within the intraoperative imaging suite if formed of a conductive material. In particular, the magnetic resonance imaging system may generate strong time-varying electromagnetic fields that induce currents in conductive components occupying the intraoperative imaging suite. A conductive driveshaft may therefore re-radiate these induced currents as radio-frequency noise, which may degrade image quality of the intraoperative imaging suite or otherwise interfere with the receive chain of the intraoperative imaging suite. Accordingly, the non-conductive driveshaft 150 is formed of a non-conductive and non-magnetic material in order to limit radio-frequency coupling and magnetic interaction between the non-conductive driveshaft 150 and the magnetic field generated by the intraoperative imaging suite.

Furthermore, current passing through the motor driver 164, the slip-rings 122, and the coil windings 114 on the rotor 110 may generate electromagnetic noise. Because the non-conductive driveshaft 150 is formed of a non-conductive and nonmagnetic material, the non-conductive driveshaft 150 may exhibit minimal or no re-radiation of this internal electromagnetic noise beyond the housing 140.

For example, the non-conductive driveshaft 150 can be formed of a polymer or composite material that exhibits stiffness, dimensional stability, and resistance to deformation under torque load while generating negligible Eddy currents in the presence of the magnetic field of the intraoperative imaging suite, such as: PEEK; carbon-fiber-reinforced PEEK; glass-filled PEEK; PPS; glass-filled PPS; or a ceramic (e.g. ; zirconia; alumina).

As described above, the non-conductive driveshaft 150: can be coupled to (e.g., fastened to, compression fit into) or integral (e.g., forming a unitary structure) with the flexspline cup 134, as shown in FIGS. 2 and 1, respectively; is configured to rotate about the rotor axis; supported by one or more bearings or bushings (e.g., ceramic ball bearings) arranged within the driveshaft aperture 142; and is constrained axially by the housing 140 and the wave-generator bearing 132 via the flexspline cup 134. The non-conductive driveshaft 150 can also include an external coupling feature (e.g., a key, a spline, a threaded interface) configured to couple the non-conductive driveshaft 150 to an external mechanism or load, such as an adjacent robotic arm segment 220.

### 8. External Electromagnetic Shield

The drive unit 100 can further include an external first electromagnetic shield 170 arranged on the housing 140 (and/or the circular-spline ring 136) and configured to attenuate transmission of electromagnetic fields (or signals)-generated by the coil windings 114 on the rotor 110 and other conductive components within the drive unit 100—beyond the housing 140, such as by forming a Faraday cage around the housing 140.

(The first electromagnetic shield 170 is described as located on an outer surface of the housing 140. However, the first electromagnetic shield 170 can be arranged in whole or in part on the inner surface of the housing 140 in order to reduce total area—and therefore total conductive material volume—of the first electromagnetic shield 170.)

### 8.1 Shield Material and Application

In one implementation, the first electromagnetic shield 170: includes a non-ferrous conductive coating extending across a first surface of the housing 140; defines an array of opens (or openings, apertures, pores) that form discontinuities in the non-ferrous conductive coating and thus interrupt Eddy-current loops within the non-ferrous conductive coating; and extends proximal and around the driveshaft aperture 142 of the housing 140.

In one example, the first electromagnetic shield 170 includes a copper or copper-alloy (e.g., bronze) film or coating electroplated, electroless plated, sputtered, or bonded to the outer (and/or inner) face of the housing 140. For example, the first electromagnetic shield 170 can extend around a bottom edge of the housing 140 into a base receptacle defined by the housing 140; and the housing 140 can include a trace configured to contact the first electromagnetic shield 170—and thus couple the first electromagnetic shield 170 to a ground plane on the base 160—when the base 160 is installed in the base receptacle on the housing 140.

In another implementation, the first electromagnetic shield 170 includes a conductive film or coating electroplated, electroless plated, sputtered, or bonded to a thermoplastic sheath, which is shrink-wrapped around the housing 140 and electrically coupled to a passive or active ground plane. For example, the conductive film or coating can be applied to the interior face of the thermoplastic sheath; and the base 160 can include a second electromagnetic shield 172—in the form of a trace—on an outer layer of the base 160, which makes electrical contact with conductive film or coating when the thermoplastic sheath is shrunk over the housing 140, thereby connecting the first electromagnetic shield 170 to the second electromagnetic shield 172 and to a ground plane on the base 160.

### 8.2 Shield Opens

The first electromagnetic shield 170 can also include opens between 0.0015″ and 0.0040″ (or between 0020″ and 0.0030″) in width with an open ratio between 25% and 40% (or between 30% and 35%) in order to balance a) radio-frequency attenuation around the operating frequency of the intraoperative imaging suite (e.g., ˜128 MHz at 3 T) with b) attenuation of Eddy currents in the first electromagnetic shield 170. In this example, the first electromagnetic shield 170 can include or approximate 200×200 mesh with a 0.002″ wire diameter.

Additionally or alternatively, the first electromagnetic shield 170 can be segmented into panels that are electrically interconnected and arranged across discreet regions of the housing 140. However, the first electromagnetic shield 170 can include any other material defining any other open ratio or open size and applied in any other way to the housing 140.

### 8.3 Shield Coverage and Termination

The first electromagnetic shield 170 can extend across all exterior surfaces—including sidewalls, edges, and corners—of the housing 140; extend up to an edge of the driveshaft aperture 142 such that the first electromagnetic shield 170 forms a continuous conductive boundary around the driveshaft aperture 142; and similarly extend up to edges of all other penetrations (e.g., optical ports 144 and pneumatic ports 146 described below) in the housing 140 in order to form a continuous conductive boundary around these penetrations.

In particular, extension of the first electromagnetic shield 170 up to the edge of the driveshaft aperture 142 and other penetrations in the housing 140 may: reduce fringing fields; limit slot-antenna; and suppress radio-frequency leakage paths from the interior of the drive unit 100 to the intraoperative imaging suite at the aperture and penetrations. For example, by extending up the driveshaft aperture 142 and other penetrations, the first electromagnetic shield 170 can: reduce or eliminate a high-impedance gap that can re-radiate switching and commutation noise from the intraoperative imaging suite; and instead present a low-impedance return path, contain displacement currents, and preserve radio-frequency suppression of the first electromagnetic shield 170 at the driveshaft aperture 142 and penetrations.

In one implementation, the first electromagnetic shield 170 further includes a short conductive lip (or “choke”) formed around edges and down faces of the driveshaft aperture 142 and other penetrations in order to further attenuate electromagnetic leakage from the housing 140.

Furthermore, the housing 140 can include filleted corners characterized by relatively large radii, and the first electromagnetic shield 170 can extend over these filleted corners, as shown in FIG. 1. In particular, these filleted corners of the housing 140 may reduce current crowding and electric-field concentration in the first electromagnetic shield 170 near sharp or small-radius edges, thereby reducing secondary radio-frequency reradiation from the first electromagnetic shield 170 near edges of the housing 140. These filleted corners of the housing 140 may also improve film or coating conformity of the first electromagnetic shield 170 across the entire housing 140, improve uniformity of surface conductivity through the first electromagnetic shield 170, and thus reduce eddy-current hot spots that may otherwise form at acute corners of the first electromagnetic shield 170 under gradient-field excitation in the presence of the magnetic field generated by the intraoperative imaging suite.

### 8.4 Active and Passive Grounding

In a passive configuration, the first electromagnetic shield 170 is electrically coupled to a local ground plane—such as a conductive ground layer of the printed circuit board—in order to provide a stable reference potential and a return path for displacement currents within the first electromagnetic shield 170.

Alternatively, in an active configuration, the first electromagnetic shield 170 is electrically coupled: to a controlled reference potential, such as controlled by the motor driver 164 within the drive unit 100; or to a system-level ground reference outside the magnetic resonance imaging machine, such as controlled by an external motor controller or robotic arm controller. In this active grounding configuration, the first electromagnetic shield 170 can form a low-impedance path and/or an active filter network that: stabilizes the potential of the first electromagnetic shield 170 relative electrical components within the drive unit 100; and/or suppresses differential-mode currents that may arise between different conductive elements within the drive unit 100. Additionally or alternatively, in this active configuration, the drive unit 100 can maintain the potential of the first electromagnetic shield 170 near zero volts relative to the radio-frequency ground plane of the intraoperative imaging suite in order to limit re-radiation of radio-frequency noise from components within the drive unit 100.

### 9. Base+Motor Driver

As shown in FIG. 2, the base 160 cooperates with the housing 140 (and/or the circular-spline ring 136): to enclose the rotor 110, the slip-ring assembly 120, the wave-generator bearing 132, and the flexspline cup 134; and to locate the slip-ring assembly 120 (or a lower bearing supporting the rotor 110) relative to the housing 140.

In one implementation, the base 160 includes a printed circuit board (or “PCB”): configured to rigidly couple the slip-ring assembly 120, the circular-spline ring 136, and the housing 140; including a set of motor control traces; and including a metallic layer forming a second electromagnetic shield 172 (e.g., across a bottom layer of the PCB) electrically coupled to the first electromagnetic shield 170 and cooperating with the first electromagnetic shield 170 to attenuate propagation of electromagnetic fields—generated by the set of hollow-core coil windings 114—beyond the base 160. In this implementation, the drive unit 100 also includes a motor driver 164: arranged on (e.g., soldered to) the printed circuit board; electrically coupled to the slip-ring assembly 120 via the set of motor control traces; and configured to selectively supply electrical current to the set of hollow-core coil windings 114, via the set of motor control traces, to generate magnetic dipoles that interact with the magnetic field generated by the magnetic resonance imaging machine to rotate the rotor 110 about the rotor axis.

For example, the base 160 can include a multi-layer PCB that includes: pads—on an inner face of the PCB—configured to solder to the motor driver 164 and the slip-ring assembly 120; and an outer conductive layer that spans the full area of the base 160 to form the second electromagnetic shield 172. For example, the outer conductive layer can be etched to form opens that interrupt Eddy-current loops within this second electromagnetic shield 172, such as described above.

Thus, in this implementation, the base 160 can function as: a rigid structure that encloses the housing 140; a mechanical interface that locates the slip-ring assembly 120 (or the lower bearing of the rotor 110) relative to the housing 140; an electrical bus that distributes data and power signals between the motor driver 164, the rotor 110, other electrical components within the drive unit 100, and/or an external motor controller or robotic arm controller; and a second electromagnetic shield 172 that cooperates with the first electromagnetic shield 170 on the housing 140 to attenuate propagation of electromagnetic fields, generated by electrical components within the drive unit 100, beyond the housing 140.

### 10. Encoders

As shown in FIG. 2, the drive unit 100 can also include both rotor and driveshaft encoders that output signals representing angular position changes or absolute positions of the rotor 110 and the non-conductive driveshaft 150, respectively.

In one implementation, the rotor encoder includes: a first optical encoder disk 184 coupled to the rotor 110, such as between the base 160 and the coil windings 114; and a first optical detector 186 mounted on the base 160 (e.g., adjacent the slip-ring assembly 120) and facing the optical encoder. In this implementation, the motor driver 164 can: access a signal from the first optical detector 186; interpret an absolute position of the rotor 110 within the housing 140 based on this signal; and vary power signals (e.g., phase, phase offset, voltage) supplied to each coil winding-via the slip-rings 122-based on the position of the rotor 110 in order to control direction, speed, and torque output of the rotor 110.

Similarly, the non-conductive driveshaft 150 encoder can include: a second optical encoder disk 180 arranged on the non-conductive driveshaft 150; and an optical detector mounted to the housing 140 and facing the second optical encoder 182. In this implementation, the motor driver 164 (or an external motor controller) can: access a signal from this second optical encoder 182; and interpret an absolute position and/or speed of the non-conductive driveshaft 150 relative to the housing 140 based on this signal. The motor driver 164 can then vary power signals (e.g., phase, phase offset, voltage) supplied to each coil winding 114 via the slip-rings 122 in order to control direction, speed, and/or position of the rotor 110, thereby rotating the non-conductive driveshaft 150—at a speed reduction via the strain-wave transmission 130—if this absolute position of the non-conductive driveshaft 150 differs from a target position or if a speed of the non-conductive driveshaft 150 differs from a target speed.

More specifically, the first optical encoder disk 184 can be arranged directly on the rotor 110 and is read by the first optical detector 186 to directly track motion and/or position of the rotor 110 in order to enable the motor driver 164 to modulate control signals to achieve rotation and torque output of the rotor 110. The second optical encoder disk 180 can be arranged directly on the non-conductive driveshaft 150 and can be read by the second optical detector 182 to directly track motion and/or position of the non-conductive driveshaft 150 relative to the housing 140 and thus enable the motor driver 164 or the motor controller to track the position of a second element (e.g., robotic arm segment 220) driven by the drive unit 100. In particular, the non-conductive driveshaft 150 may twist under torque applied by the rotor 110 and the strain-wave gearbox and may exhibit greatest twist outside of the housing 140. Therefore: the second optical encoder disk 180 can be arranged near a distal end of the non-conductive driveshaft 150 outside of the housing 140; the housing 140 can define an optical port 144 adjacent the driveshaft aperture 142; and the second optical detector 186 can be arranged within the housing 140, can face the optical port 144, and can define a field of view intersecting the second optical encoder. Thus, the second optical encoder disk 184 and the second optical detector 186 can directly track the true position of the distal end of the non-conductive driveshaft 150—and an element connected thereto—relative to the housing 140 and regardless of angular deformation (or “twist”) of the non-conductive driveshaft 150 while the second optical detector 186 remains fully within and shielded by the first electromagnetic shield 170. The first electromagnetic shield 170 can also: extend proximal and around this optical port 144; and attenuate propagation of electromagnetic fields, generated by the set of hollow-core coil windings 114, through the optical port 144, as described above.

### 10. Brake

In one variation shown in FIGS. 1 and 2, the drive unit 100 also includes a brake 190 configured to selectively engage (or “lock”) and disengage (or “unlock”) rotation of the non-conductive driveshaft 150. In particular, rather than supply electrical current to the rotor 110 to hold a position of the rotor 110 and thus retain a position of the non-conductive driveshaft 150 via the strain-wave gearbox, the drive unit 100 can actuate the brake 190—operating directly on the non-conductive driveshaft 150 (or the flexspline cup 134)—to lock rotation of the non-conductive driveshaft 150 against the housing 140. Thus, the brake 190 can hold the position of the non-conductive driveshaft 150 in place of supplying current to the rotor 110, thereby reducing generation of electromagnetic noise at the coil windings 114 that may interfere with the magnetic element of the intraoperative imaging suite and reduce imaging quality of the intraoperative imaging suite.

### 10.1 Friction Brake+Pneumatic Control

Generally, the drive unit 100 can also include a default-active brake configured to mechanically hold (i.e., stop, brake, retain) the non-conductive driveshaft 150 against the housing 140 when the drive unit 100 is not operated, thereby enabling the motor drive, the motor controller, and/or the robotic arm controller to cease current flow through the coil windings 114—and thus reduce electromagnetic noise generated by the drive unit 100—without loss of position holding by the drive unit 100.

In one implementation shown in FIG. 2, the brake 190 includes: a friction disk 192 coupled to the non-conductive driveshaft 150 and arranged within the housing 140; a pressure plate 194 coupled to the housing 140; a spring 198 configured to bias the pressure plate 194 against the friction disk 192 to brake the non-conductive driveshaft 150 against the housing 140 in a nominal or unactuated position; and a pneumatic brake actuator 196 configured to drive the pressure plate 194 off of the friction disk 192—and against the spring 198 to release the non-conductive driveshaft 150 to rotate within the housing 140—responsive to an increase in air pressure from a pneumatic supply line coupled to the drive unit 100.

For example, in this implementation, the friction disk 192 can be arranged on the top of the flexspline cup 134 around the non-conductive driveshaft 150; and the pressure plate 194 can be arranged between the friction disk 192 and the top of the housing 140 (or the circular-spline ring 136) and around the non-conductive driveshaft 150. The spring 198 (e.g., a metallic spring, a sealed bladder, a compressible elastic block) can be arranged between the pressure plate 194 and the top of the housing 140 and can bias the pressure plate 194 downward and against the friction disk 192. The pneumatic brake actuator 196 (e.g., an expandable bladder, a pneumatic plunger) forms a throwout bearing coupled to the pressure plate 194 (e.g., interposed between the pressure plate 194 and the friction disk 192) and can draw the pressure plate 194 off of the friction disk 192 when supplied with air (or other fluid) at increased pressure. Thus, in this implementation, the brake 190 can form a coaxial default-engaged friction clutch acting directly on the non-conductive driveshaft 150 and/or the flexspline cup 134.

In another implementation shown in FIG. 1, the brake 190 can include: a cylindrical friction surface located on the outer surface of flexspline cup 134 near the non-conductive driveshaft 150 (e.g., proximal a top of the flexspline cup 134); a set of shoes arranged on (e.g., pivotably coupled to) the housing 140 (or the circular-spline ring 136); a spring 198 configured to bias (or “close”) the set of shoes against the cylindrical friction surface in order to brake the flexspline cup 134 and the non-conductive driveshaft 150 against the housing 140; and a pneumatic brake actuator 196 (e.g., a pneumatic wheel cylinder) configured to expand the brake shoes—against the spring 198—when supplied with air (or other fluid) at increased pressure, thereby expanding the brake shoes, releasing the brake shoes from the cylindrical friction surface, and releasing the flexspline cup 134 and the non-conductive driveshaft 150 to rotate within the housing 140. Thus, in this implementation, the brake 190 can form a radial default-engaged drum brake acting directly on the flexspline cup 134.

For example, in the foregoing implementations, the pneumatic brake actuator 196 can include: a non-conductive (e.g., polymer) cylinder coupled to a pneumatic port 146 arranged on the housing 140; and a non-conductive piston running in the cylinder and configured to act on (i.e., release) the pressure plate 194 or the brake shoes when air is supplied under pressure to the pneumatic port 146, such as by an external air supply coupled to the pneumatic port 146 and controlled by the motor controller or the robotic system controller.

Thus, in this implementation, the housing 140 can include a pneumatic port 146 configured to couple the pneumatic supply line to the pneumatic brake actuator 196. Accordingly, the non-ferrous conductive coating of the first electromagnetic shield 170 can extend across the surface of the housing 140 and extend proximal and around both the driveshaft aperture 142 and the pneumatic port 146 in order to attenuate propagation of electromagnetic fields—generated by the set of hollow-core coil windings 114—through the driveshaft aperture 142 and the pneumatic port 146.

### 10.2 Alternative Brake Actuator

Alternatively, the brake actuator 196: can be coupled to a hydraulic supply line—rather than a pneumatic supply line—controlled by the motor controller or the robotic system controller; and can be configured to act on (i.e., release) the pressure plate 194 or the brake shoes of the brake 190 when hydraulic fluid is supplied under pressure to the brake actuator 196.

In another implementation, the brake actuator 196 includes a piezoelectric element (e.g., a stack flexural piezo elements): coupled to the pressure plate 194 or the brake shoes of the brake 190; configured to deform along a longitudinal or shear axis when energized, such as via power supplied by the motor driver 164 or the external motor controller or robotic arm controller; and thus configured to withdraw the pressure plate 194 from the friction disk 192 or to release the brake shoes from the cylindrical friction surface when energized.

In another implementation, the brake actuator 196 includes a solenoid coil element: coupled to the pressure plate 194 or the brake shoes of the brake 190; configured interact with magnetic fields generated by the intraoperative imaging suite to produce a force or torque when energized, such as via power supplied by the motor driver 164, the external motor controller, or the robotic arm controller; and thus configured to withdraw the pressure plate 194 from the friction disk 192 or to release the brake shoes from the cylindrical friction surface when energized.

However, the brake actuator 196 can include any other type of actuator operated in any other way to selectively release the brake 190—and thus enable the non-conductive driveshaft 150 to rotate within the housing 140—as the motor driver 164 increases current flow to the coil windings 114, which causes the rotor 110, the flexspline cup 134, and thus the non-conductive driveshaft 150 to rotate.

### 11. Hollow Driveshaft

In one implementation shown in FIG. 2, the rotor 110, the slip-ring assembly, the flexspline cup 134, the non-conductive driveshaft 150, the housing 140, and/or the base 160 cooperate to define a through-bore along the rotor axis and through the drive unit 100. The drive unit 100 can thus receive a surgical instrument—such as a cannula, guide tube, or needle—or other elongated end effector 230 within this coaxial through-bore.

Furthermore, the drive unit 100 can also include an engagement feature (e.g., a spline, a key) arranged on the non-conductive driveshaft 150 or within this coaxial through-bore and configured to rotationally constrain a surgical tool loaded into the coaxial through-bore. The drive unit 100 can thus rotate this surgical tool about the rotor axis by energizing the coil windings 114.

For example, the rotor 110 can define a first through-bore coaxial with the rotor axis. The housing 140 can define a rear aperture opposite the driveshaft aperture 142 and coaxial with the rotor axis. The non-conductive driveshaft 150 can define a second through-bore coaxial with the rotor axis. The slip-ring assembly 120 can include a slip-ring column 124: extending into the first through-bore of the rotor 110; and defining a third through-bore coaxial with the rotor axis. Accordingly, the set of slip-rings 122 can be arranged on the slip-ring column 124; and the second through-bore of the non-conductive driveshaft 150 and the third through-bore of the slip-ring column 124 can cooperate to define a continuous through-bore-through the housing 140—configured to receive a surgical instrument.

Additionally or alternatively, the rotor 110, the slip-ring assembly, the flexspline cup 134, the non-conductive driveshaft 150, the housing 140, and/or the base can 160 cooperate to define the through-bore—along the rotor axis and through the drive unit 100—through which electrical wires may be passed from the drive unit 100 to a next drive unit 100 coupled or mounted to the non-conductive driveshaft 150.

### 12. Variation: Segmented Electromagnetic Shield

In another variation shown in FIG. 2, the drive unit 100 includes a set of discrete electromagnetic shields: each configured to enclose one or a small subset of electrical or conductive elements of the drive unit 100; and in aggregate spanning a smaller surface area—and thus containing a small mass and volume of conductive material—than a single electromagnetic shield arranged across the surface of the housing 140.

In one implementation, the base 160: is configured to rigidly couple the slip-ring assembly 120, the circular-spline ring 136, and the housing 140; and includes a printed circuit board including a metallic layer that forms a second electromagnetic shield 172. The motor driver 164: is arranged on the printed circuit board; and is configured to selectively supply electrical current to the set of hollow-core coil windings 114 to generate magnetic dipoles that interact with the magnetic field generated by a magnetic resonance imaging machine to rotate the rotor 110 about the rotor axis. A third electromagnetic shield 174: is arranged over the motor driver 164; is electrically coupled to the second electromagnetic shield 172; and cooperates with the second electromagnetic shield 172 to attenuate propagation of electromagnetic fields, generated by the motor driver 164, toward the housing 140. A first electromagnetic shield 170: is arranged about the set of hollow-core coil windings 114; is electrically coupled to the second electromagnetic shield 172 and the third electromagnetic shield 174; and cooperates with the second electromagnetic shield 172 to attenuate propagation of electromagnetic fields, generated by the set of hollow-core coil windings 114, beyond the flexspline cup 134.

In this implementation, the first electromagnetic shield 170 can be arranged (e.g., bonded, plated, sputtered, and/or etched) on the flexspline cup 134 and can include a shield contact extending toward the rotor axis. The slip-ring assembly 120 can include: a first set of slip-rings 122 configured to electrically couple the motor driver 164 to the set of hollow-core coil windings 114 via the set of rotor contacts 116; and a second slip-ring configured to electrically couple the first electromagnetic shield 170 to the second electromagnetic shield 172 and/or to a ground plane via the shield contact. Thus, in this implementation, an electromagnetic shield can be directly incorporated onto the flexspline cup 134 and can attenuate a magnetic field generated by the coil windings 114 with less total conductive material than a larger electromagnetic shield arranged on the housing 140 or the circular-spline ring 136.

Alternatively, the first electromagnetic shield 170 can include: a thermoplastic sheath shrink-wrapped around the set of hollow-core coil windings 114; a conductive coating arranged over the thermoplastic sheath; and a shield contact electrically coupled to the conductive coating and extending toward the rotor axis. The slip-ring assembly 120 can include: a first set of slip-rings 122 configured to electrically couple the motor driver 164 to the set of hollow-core coil windings 114 via the set of rotor contacts 116; and a second slip-ring 122 configured to electrically couple the first electromagnetic shield 170 to the second electromagnetic shield 172 and/or to a ground plane via the shield contact. Thus, in this implementation, an electromagnetic shield can be shrink-wrapped directly around the rotor 110 and can attenuate a magnetic field generated by the coil windings 114 with less total conductive material than a larger electromagnetic shield arranged on the flexspline cup 134, the housing 140, or the circular-spline ring 136.

Similarly, the third electromagnetic shield 174 can include a small polymer enclosure: including the conductive coating; bonded or soldered to the base 160 over the motor driver 164; and configured to attenuate electromagnetic noise generated by the motor drive and emanating opposite the base 160.

The drive unit 100 can include additional small electromagnetic shield enclosures, such as arranged over optical emitters of the non-conductive driveshaft 150 and rotor encoders.

In this implementation, the second electromagnetic shield 172 on the base 160 can extend fully across the area of the base 160, as described above. Alternatively, the second electromagnetic shield 172 can include smaller discrete segments that face conductive elements (e.g., the motor driver 164, the coil windings 114) within the drive unit 100 that cooperate with other smaller electromagnetic shields within the drive unit 100 to electrically enclose these elements.

As described above, these smaller electromagnetic shields can be collectively coupled to a ground plane.

### 13. Orthogonal Rotors+Coupled Transmissions

In another variation, the drive unit 100 includes: a second rotor configured to rotate about a second rotor axis orthogonal to the (first) rotor axis; a second slip-ring assembly 120 coupled to the second rotor; and a second strain-wave transmission 130 driven by the second rotor and coupled to the (first) strain-wave transmission 130, such as via a pair of 90° miter gears arranged on the flexspline cups 134 of these strain-wave transmissions 130. In particular, because the drive unit 100 leverages the magnetic field generated by the intraoperative imaging suite for an external stator field while also rotating the rotate output of alignment with this external stator field, the peak torque output by the (first) rotor 110 may decrease as an angle between the (first) rotor axis and the Bo field of the intraoperative imaging suite deviates from orthogonal (or 90°). However, a second similar rotor 110 and second strain-wave transmission 130—orthogonal and geared to the (first) rotor 110 and the (first) strain-wave transmission 130—may exhibit increasing peak torque output as this angle between the (first) rotor axis and the Bo field of the intraoperative imaging suite approaches orthogonal. Therefore, the drive unit 100 can include a second similar rotor 110 and second strain-wave transmission 130—orthogonal and geared to the (first) rotor 110 and the (first) strain-wave transmission 130—in order to achieve more uniform peak torque output from the drive unit 100 over a range of angular positions of the drive unit 100 relative to the Bo field of the intraoperative imaging suite. (The drive unit 100 can also include a third similar rotor 110 and third strain-wave transmission 130—orthogonal and geared to these rotors 110 and strain-wave transmissions 130.)

For example, the drive unit 100 can include: a second rotor; a second slip-ring assembly 120; and a second strain-wave transmission 130. The second rotor: is configured to rotate about a second rotor axis perpendicular to the rotor axis; includes a second set of hollow-core coil windings 114 configured to generate magnetic dipoles that interact with the magnetic field generated by the magnetic resonance imaging machine to rotate the second rotor about the second rotor axis; and includes a second set of rotor contacts 116 electrically coupled to the second set of hollow-core coil windings 114 and extending toward the second rotor axis. The second slip-ring assembly 120: is coaxial with the second rotor axis; is arranged within the second rotor; and includes a second set of slip-rings 122 configured to electrically couple to the second set of rotor contacts 116. The second strain-wave transmission 130 includes: a second wave-generator bearing 132 coupled to the second rotor and laterally adjacent the second hollow-core coil windings 114; a second flexspline cup 134 arranged about the second wave-generator bearing 132, configured to rotate about the second rotor axis, and geared to the flexspline cup 134; and a second circular-spline ring 136 arranged about the second flexspline cup 134 and coaxial with the second rotor. In this example, the housing 140 can further contain the second rotor, the second slip-ring assembly 120, the second wave-generator bearing 132, and the second flexspline cup 134. The non-conductive driveshaft 150 can thus further output torque: generated by the second set of hollow-core coil windings 114 interacting with the magnetic field generated by the magnetic resonance imaging machine; and transmitted from the second rotor to the non-conductive driveshaft 150 by the second strain-wave transmission 130.

In a similar variation, the drive unit 100 includes: a second rotor configured to rotate about a second rotor axis orthogonal to the (first) rotor axis and coupled to the (first) rotor 110, such as via a pair of 90° miter gears; and a second slip-ring assembly 120 coupled to the second rotor. In this variation, the wave-generator bearing 132 is coupled to the (first) rotor 110. The flexspline cup 134: is arranged about (e.g., encompasses) both the (first) rotor 110 and the second rotor; and is deformed by the wave-generator bearing 132. Thus, because the drive unit 100 leverages the magnetic field generated by the intraoperative imaging suite for an external stator field while also rotating the rotate output of alignment with this external stator field, the peak torque output by the (first) rotor 110 may decrease as an angle between the (first) rotor axis and the B₀ field of the intraoperative imaging suite deviates from orthogonal (or 90°). However, a second similar rotor 110—orthogonal and geared to the (first) rotor 110 and contained within the strain-wave transmission 130—may exhibit increasing peak torque output as this angle between the (first) rotor axis and the Bo field of the intraoperative imaging suite approaches orthogonal. Therefore, the drive unit 100 can include a second similar rotor 110—orthogonal and geared to the (first) rotor 110 and contained within the strain-wave transmission 130—in order to achieve more uniform peak torque output from the drive unit 100 over a range of angular positions of the drive unit 100 relative to the B₀ field of the intraoperative imaging suite. (The drive unit 100 can also include a third similar rotor 110—orthogonal and geared to the (first) rotor 110, the second rotor, and strain-wave transmission 130.)

### 14. Variation: Driveshaftless Statorless Gearhead Motor

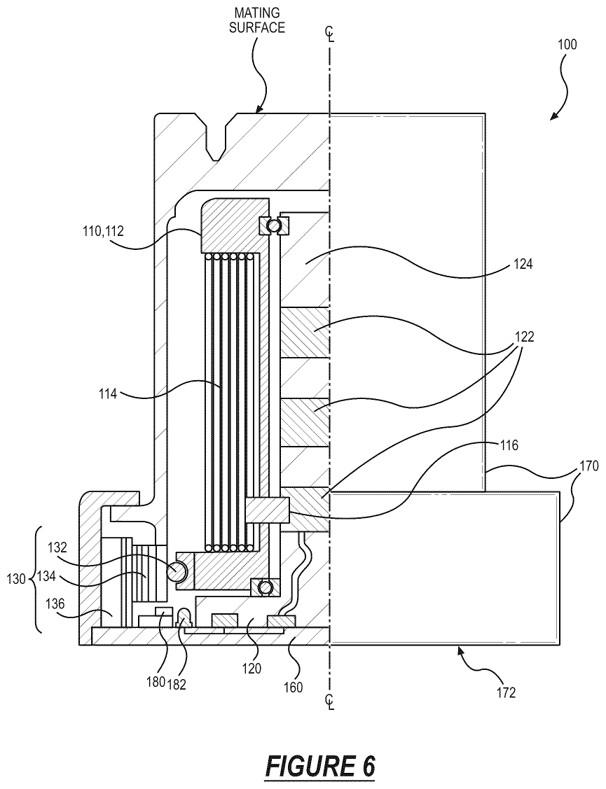

In one variation shown in FIG. 6, drive unit 100 forms a driveshaftless statorless gearhead motor. Specifically, in this variation, the flexspline cup 134 defines a mounting interface opposite the base 160, such as a flat or tapered mating surface with smooth or threaded bores to enable an end of a robotic arm segment 220 to be fastened directly to the flexspline cup 134 opposite the base. In this variation, the flexspline cup 134 can also define the housing 140 or can cooperate with the circular-spline ring 136 and/or the base 160 to define the housing; and the electromagnetic shield 170 can be arranged on the flexspline cup 134, such as similar to arrangement of the electromagnetic shield 170 on the circular-spline ring 136 described above.

In this variation, the flexspline cup 134 can also define upper and lower axial thrust surfaces, such as facing opposite (e.g., above and below) its external gear teeth. The circular-spline ring 136 can define corresponding axial thrust bearings that mate with these upper and lower axial thrust surfaces to constrain the flexspline cup 134 to the circular-spline ring 136 in axial translation and non-axial rotation. The internal teeth of the circular-spline ring 136 can mesh with the external gear teeth of the flexspline cup 134—deformed by the wave-generator bearing 132—to constrain the flexspline cup 134 to the circular-spline ring 136 in lateral and longitudinal translation and axial rotation.

### 15. Alternative Power Transmission

As described above, the drive unit 100 can include a strain-wave transmission 130 nested around and concentric with the rotor 110.

Alternatively, the drive unit 100 can include a cycloidal transmission (or “gearbox”), such as including: a ring gear defining fixed ring pins and physically coextensive with the housing 140; a cycloidal disk configured to rotate eccentrically within the ring gear; and an eccentric pin disk arranged on or integrated into the rotor 110 and configured to drive the cycloidal disk about the ring gear.

Alternatively, the drive unit 100 can include a concentric planetary transmission, such as including: a ring gear physically coextensive with the housing 140; and a sun gear arranged on or integrated into the rotor 110 and rotating about the rotor axis.

However, the power transmission 130 can include any other type or form of coaxial or non-coaxial transmission.

### 16. Robotic Arm Configuration

Generally, multiple similar or identical instances of the drive unit 100 can be integrated into joints of a robotic arm 200—including a robotic arm base 210, a robotic arm segment 220, and an end effector 230—to articulate elements of the robotic arm 200, as shown in FIGS. 5A, 5B, and 5C.

In one implementation, the rotor 110, the slip-ring assembly 120, the strain-wave transmission 130, the housing 140, and the non-conductive driveshaft 150 collectively define a first drive unit 100 (or “statorless gearhead motor”) interposed between the robotic arm base 210 and the robotic arm segment 220 and configured to drive the robotic arm segment 220 over a first range of positions on the robotic arm base 210.

In this implementation, the robotic arm 200 can further include a second drive unit 100 interposed between the robotic arm segment 220 and the end effector 230 and configured to drive the end effector 230 over a second range of positions on the robotic arm segment 220. The second drive unit 100 can include a second rotor: configured to rotate about a second rotor axis; including a second set of hollow-core coil windings 114 configured to generate magnetic dipoles that interact with the magnetic field generated by the magnetic resonance imaging machine to rotate the second rotor about the second rotor axis; and including a second set of rotor contacts 116 electrically coupled to the second set of hollow-core coil windings 114 and extending toward the second rotor axis. The second drive unit 100 can further include a second slip-ring assembly 120: coaxial with the second rotor axis; arranged within the second rotor; and including a second set of slip-rings 122 configured to electrically couple to the second set of rotor contacts 116. The second drive unit 100 can also include a second strain-wave transmission 130: including a second wave-generator bearing 132 coupled to the second rotor and laterally adjacent the second set of hollow-core coil windings 114; a second flexspline cup 134 arranged about the second wave-generator bearing 132 and configured to rotate about the second rotor axis; and a second circular-spline ring 136 arranged about the second flexspline cup 134 and coaxial with the second rotor.

The second drive unit 100 can further include a second housing 140: containing the second rotor, the second slip-ring assembly 120, the second wave-generator bearing 132, and the second flexspline cup 134; and defining a second driveshaft aperture 142. A second non-conductive driveshaft 150: is coupled to the second strain-wave transmission 130; extends through the second driveshaft aperture 142 of the second housing 140; and is configured to output torque a) generated by the second set of hollow-core coil windings 114 interacting with the magnetic field generated by the magnetic resonance imaging machine and b) transmitted from the second rotor to the second non-conductive driveshaft 150 by the second strain-wave transmission 130.

Thus, in this implementation, each instance of the drive unit 100 (i.e., each drive unit 100) can operate independently or in coordination to position the end effector 230 within the intraoperative imaging suite while limiting emission of magnetic fields and radio-frequency noise that may degrade imaging by the intraoperative imaging suite. Because each drive unit 100 includes a high-gear-reduction power transmission 130, including a brake 190 acting directly on its non-conductive driveshaft 150, and leverages the magnetic field generated by the magnetic resonance imaging machine for its stator field, the robotic arm 200 can execute precise, low-noise motions within the imaging bore of the intraoperative imaging suite without introducing (substantive masses of) ferrous or magnetic materials or radio-frequency interference within the Bo field of the intraoperative imaging suite. The non-conductive driveshafts 150, electromagnetic shielding, and non-ferrous structural materials of each drive unit 100 can also limit generation of Eddy currents within the drive units 100 and thus limit distortion of the magnetic field of the intraoperative imaging suite during imaging sequences.

### 16.1 Interconnected Drive Unit Shielding

Furthermore, in this configuration in which multiple instances of the drive unit 100 are assembled to form a robotic arm 200, the electromagnetic shields of these drive units 100 can be coupled to a common ground plane in order to maintain a uniform reference potential along the robotic arm 200, thereby suppressing differential-mode noise between adjacent drive units 100.

In one implementation, a first electromagnetic shield 170 includes a non-ferrous conductive coating: extending across a first surface of the housing 140 of the first drive unit 100; extending proximal to and around the driveshaft aperture 142 of the housing 140; and configured to attenuate propagation of electromagnetic fields generated by the set of hollow-core coil windings 114 beyond the housing 140 and through the driveshaft aperture 142. Similarly, a second electromagnetic shield 172 includes the non-ferrous conductive coating: extending across a second surface of the housing 140 of the second drive unit 100; extending proximal to and around the second driveshaft aperture 142; and configured to attenuate propagation of electromagnetic fields generated by the second set of hollow-core coil windings 114 beyond the second housing 140 and through its driveshaft aperture 142. The second electromagnetic shield 172 can be electrically coupled to the first electromagnetic shield 170—such as by a conductive strap, a gasket, or a braid integrated into the robotic arm segment 220 arranged between these drive units 100—in order to form a continuous return path that connects these electromagnetic shields to the common ground plane.

Thus, each electromagnetic shield can maintain the same electrical potential as the adjacent shield and as the ground reference of the control electronics. This continuity may prevent accumulation of charge on isolated housings 140 and may suppress capacitive coupling as two drive units 100 pass each other during articulation of the end effector 230, which could otherwise cause local re-radiation of radio-frequency noise into the magnetic field of the intraoperative imaging suite. The continuous ground connection between these electromagnetic shields may also form a low-impedance path for displacement currents induced by time-varying magnetic fields in the imaging bore of the intraoperative imaging suite, thereby preserving effectiveness of the electromagnetic shields of these drive units 100.

### 16.2 Motor Control

In one implementation, the motor drivers 164 of multiple drive units 100 are electrically coupled in series (or “daisy-chained”) in order to reduce a count of electrical ports, connectors, and wires extending from an external motor controller or robotic arm controller and the drive units 100 in the robotic arm 200. Accordingly, a first motor driver 164 in a first drive unit 100 in the robotic arm 200 (e.g., in the robotic arm base 210) can: receive power and control signals for the entire robotic arm 200 from the external motor controller or robotic arm controller over a small count of wires (e.g., a common ground wire, single power wire, and a single data wire), such as via I²C, EtherCAT, or CAN communication protocol; extract a first position or speed command assigned to its non-conductive driveshaft 150 from data received over the single data wire; supply power from the single power wire to its coil windings 114 in order to realize this first position or speed command at its non-conductive driveshaft 150; return positions of its non-conductive driveshaft 150—read from its driveshaft encoder—to the external motor controller or robotic arm controller over the data wire; and pass remaining commands received on the data line to the next drive unit 100. The motor driver 164 in each subsequent drive unit 100 in the robotic arm 200 can repeat this process to both realize a pose of the robotic arm 200 and end effector 230 set by the external motor controller or robotic arm controller and to return positions of their non-conductive driveshafts 150 to the external motor controller or robotic arm controller.

In a similar implementation, these drive units 100 can be daisy-chained such that: data is carried over a single shielded twisted-pair between drive units 100; power is carried over a single two-wire DC pair; and both power and data pairs are routed alongside a bonded shield jumper (or “braid”) that ties the electromagnetic shields on each drive unit 100 to the common ground plane, thereby reducing redundant home-run cabling, limiting wire loop area, and limiting radiation of magnetic fields and radio-frequency noise from wires connecting these drive units 100 to the external motor controller or robotic arm controller.

### 16.3 Multiple Robotic Arms

Furthermore, multiple similar or identical robotic arms 200 can be arranged on the table within the imaging bore of the intraoperative imaging suite. For example, a first instance of the robotic arm 200—described above—can be configured to locate on a first (e.g., left) sagittal side of a table of the intraoperative imaging suite; and a second instance of the robotic arm 200 can be configured to locate on a second (e.g., right) sagittal side of the table adjacent and opposite the first instance of the robotic arm 200, as shown in FIGS. 5A, 5B, and 5C. These two robotic arms 200 can thus cooperate to execute surgical processes or maneuvers during an imaging-assisted surgery on a patient occupying the intraoperative imaging suite.

### 17. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a rotor:
configured to rotate about a rotor axis;
comprising a set of hollow-core coil windings configured to generate magnetic dipoles that interact with a magnetic field generated by a magnetic resonance imaging machine to rotate the rotor about the rotor axis; and
comprising a set of rotor contacts:
electrically coupled to the set of hollow-core coil windings; and
extending toward the rotor axis;
a slip-ring assembly:
coaxial with the rotor axis;
arranged within the rotor; and
comprising a set of slip-rings configured to electrically couple to the set of rotor contacts;
a strain-wave transmission comprising:
a wave-generator bearing coupled to the rotor and laterally adjacent the set of hollow-core coil windings;
a flexspline cup:
arranged about the wave-generator bearing; and
configured to rotate about the rotor axis; and
a circular-spline ring arranged about the flexspline cup and coaxial with the rotor;
a housing:
containing the rotor, the slip-ring assembly, the wave-generator bearing, and the flexspline cup; and
defining a driveshaft aperture; and
a non-conductive driveshaft:
coupled to the strain-wave transmission;
extending through the driveshaft aperture of the housing; and
configured to output torque:
generated by the set of hollow-core coil windings interacting with the magnetic field generated by the magnetic resonance imaging machine; and
transmitted from the rotor to the non-conductive driveshaft by the strain-wave transmission.

2. The system of claim 1:
further comprising a base configured to rigidly couple the slip-ring assembly to the circular-spline ring;
wherein the housing extends upwardly from the circular-spline ring opposite the base; and
wherein the circular-spline ring and the housing cooperate to define a unitary structure that contains the rotor, the slip-ring assembly, the wave-generator bearing, and the flexspline cup.

3. The system of claim 1, further comprising a first electromagnetic shield:
comprising a non-ferrous conductive coating extending across a first surface of the housing;
defining an array of opens configured to interrupt eddy-current loops within the non-ferrous conductive coating;
extending proximal and around the driveshaft aperture of the housing; and
configured to attenuate propagation of electromagnetic fields, generated by the set of hollow-core coil windings, beyond the housing and through the driveshaft aperture.

4. The system of claim [0091]:
wherein the set of hollow-core coil windings comprises non-ferrous metal wire;
wherein the slip-ring assembly comprises a slip-ring column:
extending into the rotor; and
comprising a polymer;
wherein the wave-generator bearing comprises a ceramic material;
wherein the flexspline cup comprises titanium;
wherein the circular-spline comprises the polymer;
wherein the housing comprises the polymer;
wherein the non-conductive driveshaft comprises the polymer; and
wherein the first electromagnetic shield comprises a copper alloy.

5. The system of claim [0091]:
wherein the housing further defines an optical port adjacent the driveshaft aperture;
further comprising:
an optical encoder disk arranged on the non-conductive driveshaft outside of the housing; and
an optical detector facing the optical port and defining a field of view intersecting the optical encoder disk; and
wherein the first electromagnetic shield:
further extends proximal and around the optical port of the housing; and
is further configured to attenuate propagation of electromagnetic fields, generated by the set of hollow-core coil windings, through the optical port.

6. The system of claim [0091], further comprising:
a base:
comprising a printed circuit board:
configured to rigidly couple the slip-ring assembly, the circular-spline ring, and the housing;
comprising a metallic layer:
forming a second electromagnetic shield;
electrically coupled to the first electromagnetic shield; and
configured to attenuate propagation of electromagnetic fields, generated by the set of hollow-core coil windings, beyond the base; and
comprising a set of motor control traces; and
a motor driver:
arranged on the printed circuit board;
electrically coupled to the slip-ring assembly via the set of motor control traces; and
configured to selectively supply electrical current to the set of hollow-core coil windings, via the set of motor control traces, to generate magnetic dipoles that interact with the magnetic field generated by the magnetic resonance imaging machine to rotate the rotor about the rotor axis.

7. The system of claim 1, further comprising
a base:
configured to rigidly couple the slip-ring assembly, the circular-spline ring, and the housing; and
comprising a printed circuit board comprising a metallic layer that forms a first electromagnetic shield;
a motor driver:
arranged on the printed circuit board; and
configured to selectively supply electrical current to the set of hollow-core coil windings to generate magnetic dipoles that interact with the magnetic field generated by a magnetic resonance imaging machine to rotate the rotor about the rotor axis;
a second electromagnetic shield:
arranged over the motor driver;
electrically coupled to the first electromagnetic shield; and
cooperating with the first electromagnetic shield to attenuate propagation of electromagnetic fields, generated by the motor driver, toward the housing; and
a third electromagnetic shield:
arranged about the set of hollow-core coil windings;
electrically coupled to the first electromagnetic shield and the second electromagnetic shield; and
cooperating with the first electromagnetic shield to attenuate propagation of electromagnetic fields, generated by the set of hollow-core coil windings, beyond the flexspline cup.

8. The system of claim 7:
wherein the third electromagnetic shield is arranged on the flexspline cup and comprises a shield contact extending toward the rotor axis; and
wherein the set of slip-rings are configured to:
electrically couple the motor driver to the set of hollow-core coil windings via the set of rotor contacts; and
electrically couple the third electromagnetic shield to the first electromagnetic shield via the shield contact.

9. The system of claim 7:
wherein the third electromagnetic shield comprises:
a thermoplastic sheath shrink-wrapped around the set of hollow-core coil windings;
a conductive coating arranged over the thermoplastic sheath; and
a shield contact:
electrically coupled to the conductive coating; and
extending toward the rotor axis; and
wherein the set of slip-rings are configured to:
electrically couple the motor driver to the set of hollow-core coil windings via the set of rotor contacts; and
electrically couple the third electromagnetic shield to the first electromagnetic shield via the shield contact.

10. The system of claim 1:
further comprising:
a robotic arm base;
a robotic arm segment; and
an end effector;
wherein the rotor, the slip-ring assembly, the strain-wave transmission, the housing, and the non-conductive driveshaft form a first statorless gearhead motor:
interposed between the robotic arm base and the robotic arm segment; and
configured to drive the robotic arm segment over a first range of positions on the robotic arm base; and
further comprising a second statorless gearhead motor:
interposed between the robotic arm segment and the end effector;
configured to drive the end effector over a second range of positions on the robotic arm segment; and
comprising:
a second rotor:
configured to rotate about a second rotor axis;
comprising a second set of hollow-core coil windings configured to generate magnetic dipoles that interact with the magnetic field generated by the magnetic resonance imaging machine to rotate the second rotor about the second rotor axis; and
comprising a second set of rotor contacts:
electrically coupled to the second set of hollow-core coil windings; and
extending toward the second rotor axis;
a second slip-ring assembly:
coaxial with the second rotor axis;
arranged within the second rotor; and
comprising a second set of slip-rings configured to electrically couple to the second set of rotor contacts;
a second strain-wave transmission comprising:
a second wave-generator bearing coupled to the second rotor and laterally adjacent the second hollow-core coil windings;
a second flexspline cup:
arranged about the second wave-generator bearing; and
configured to rotate about the second rotor axis; and
a second circular-spline ring arranged about the second flexspline cup and coaxial with the second rotor;
a second housing:
containing the second rotor, the second slip-ring assembly, the second wave-generator bearing, and the second flexspline cup; and
defining a second driveshaft aperture; and
a second non-conductive driveshaft:
coupled to the second strain-wave transmission;
extending through the second driveshaft aperture of the second housing; and
configured to output torque:
generated by the second set of hollow-core coil windings interacting with the magnetic field generated by the magnetic resonance imaging machine; and
transmitted from the second rotor to the second non-conductive driveshaft by the second strain-wave transmission.

11. The system of claim 10, further comprising:
a first electromagnetic shield:
comprising a non-ferrous conductive coating extending across a first surface of the housing of the first statorless gearhead motor;
extending proximal and around the driveshaft aperture of the housing of the first statorless gearhead motor; and
configured to attenuate propagation of electromagnetic fields, generated by the set of hollow-core coil windings, beyond the housing and through the driveshaft aperture of the first statorless gearhead motor; and
a second electromagnetic shield:
comprising the non-ferrous conductive coating extending across a second surface of the second housing of the second statorless gearhead motor;
extending proximal and around the second driveshaft aperture of the second housing of the second statorless gearhead motor;
configured to attenuate propagation of electromagnetic fields, generated by the second set of hollow-core coil windings, beyond the housing and through the driveshaft aperture of the housing of the second statorless gearhead motor; and
electrically coupled to the first electromagnetic shield.

12. The system of claim 10:
wherein the robotic arm base is configured to locate on a first sagittal side of a table of the magnetic resonance imaging machine; and
further comprising
a second robotic arm base configured to locate on a second sagittal side of the table of the magnetic resonance imaging machine adjacent and opposite the robotic arm base;
a second robotic arm segment;
a second end effector;
a third statorless gearhead motor:
interposed between the second robotic arm base and the second robotic arm segment;
configured to drive the second robotic arm segment over the first range of positions on the second robotic arm base; and
comprising:
a third rotor:
configured to rotate about a third rotor axis;
comprising a third set of hollow-core coil windings configured to generate magnetic dipoles that interact with the magnetic field generated by the magnetic resonance imaging machine to rotate the third rotor about the third rotor axis; and
comprising a third set of rotor contacts:
electrically coupled to the third set of hollow-core coil windings; and
extending toward the third rotor axis;
a third slip-ring assembly:
coaxial with the third rotor axis;
arranged within the third rotor; and
comprising a third set of slip-rings configured to electrically couple to the third set of rotor contacts;
a third strain-wave transmission comprising:
a third wave-generator bearing coupled to the third rotor and laterally adjacent the third hollow-core coil windings;
a third flexspline cup:
arranged about the third wave-generator bearing; and
configured to rotate about the third rotor axis; and
a third circular-spline ring arranged about the third flexspline cup and coaxial with the third rotor;
a third housing:
containing the third rotor, the third slip-ring assembly, the third wave-generator bearing, and the third flexspline cup; and
defining a third driveshaft aperture; and
a third non-conductive driveshaft:
coupled to the third strain-wave transmission;
extending through the third driveshaft aperture of the third housing; and
configured to output torque:
generated by the third set of hollow-core coil windings interacting with the magnetic field generated by the magnetic resonance imaging machine; and
transmitted from the third rotor to the third non-conductive driveshaft by the third strain-wave transmission; and
a fourth statorless gearhead motor:
interposed between the second robotic arm segment the second end effector;
configured to drive the second end effector over the second range of positions on the second robotic arm segment; and
comprising:
a fourth rotor:
configured to rotate about a fourth rotor axis;
comprising a fourth set of hollow-core coil windings configured to generate magnetic dipoles that interact with the magnetic field generated by the magnetic resonance imaging machine to rotate the fourth rotor about the fourth rotor axis; and
comprising a fourth set of rotor contacts:
electrically coupled to the fourth set of hollow-core coil windings; and
extending toward the fourth rotor axis;
a fourth slip-ring assembly:
coaxial with the fourth rotor axis;
arranged within the fourth rotor; and
comprising a fourth set of slip-rings configured to electrically couple to the fourth set of rotor contacts;
a fourth strain-wave transmission comprising:
a fourth wave-generator bearing coupled to the fourth rotor and laterally adjacent the fourth hollow-core coil windings;
a fourth flexspline cup:
arranged about the fourth wave-generator bearing; and
configured to rotate about the fourth rotor axis; and
a fourth circular-spline ring arranged about the fourth flexspline cup and coaxial with the fourth rotor;
a fourth housing:
containing the fourth rotor, the fourth slip-ring assembly, the fourth wave-generator bearing, and the fourth flexspline cup; and
defining a fourth driveshaft aperture; and
a fourth non-conductive driveshaft:
coupled to the fourth strain-wave transmission;
extending through the fourth driveshaft aperture of the fourth housing; and
configured to output torque:
generated by the fourth set of hollow-core coil windings interacting with the magnetic field generated by the magnetic resonance imaging machine; and
transmitted from the fourth rotor to the fourth non-conductive driveshaft by the fourth strain-wave transmission.

13. The system of claim 1:
wherein the rotor defines a first through-bore coaxial with the rotor axis;
wherein the housing further defines a rear aperture opposite the driveshaft aperture and coaxial with the rotor axis;
wherein the non-conductive driveshaft defines a second through-bore coaxial with the rotor axis;
wherein the slip-ring assembly comprises a slip-ring column:
extending into the first through-bore of the rotor; and
defining a third through-bore coaxial with the rotor axis;
wherein the set of slip-rings is arranged on the slip-ring column; and
wherein the second through-bore of the non-conductive driveshaft and the third through-bore of the slip-ring column cooperate to define a continuous through-bore, through the housing, configured to receive an object.

14. The system of claim 1:
further comprising:
a second rotor:
configured to rotate about a second rotor axis perpendicular to the rotor axis;
comprising a second set of hollow-core coil windings configured to generate magnetic dipoles that interact with the magnetic field generated by the magnetic resonance imaging machine to rotate the second rotor about the second rotor axis; and
comprising a second set of rotor contacts:
electrically coupled to the second set of hollow-core coil windings; and
extending toward the second rotor axis;
a second slip-ring assembly:
coaxial with the second rotor axis;
arranged within the second rotor; and
comprising a second set of slip-rings configured to electrically couple to the second set of rotor contacts; and
a second strain-wave transmission comprising:
a second wave-generator bearing coupled to the second rotor and laterally adjacent the second hollow-core coil windings;
a second flexspline cup:
arranged about the second wave-generator bearing;
configured to rotate about the second rotor axis; and
geared to the flexspline cup; and
a second circular-spline ring arranged about the second flexspline cup and coaxial with the second rotor;
wherein the housing further contains the second rotor, the second slip-ring assembly, the second wave-generator bearing, and the second flexspline cup; and
wherein the non-conductive driveshaft is further configured to output torque:
generated by the second set of hollow-core coil windings interacting with the magnetic field generated by the magnetic resonance imaging machine; and
transmitted from the second rotor to the non-conductive driveshaft by the second strain-wave transmission.

15. The system of claim 1, further comprising a brake comprising:
a friction disk coupled to the non-conductive driveshaft and arranged within the housing;
a pressure plate coupled to the housing;
a spring configured to bias the pressure plate against the friction disk to brake the non-conductive driveshaft against the housing; and
a pneumatic brake actuator configured to drive the pressure plate off of the friction disk, against the spring, to release the non-conductive driveshaft to rotate within the housing responsive to increase in air pressure from a pneumatic supply line coupled to the system.

16. The system of claim [00112]:
wherein the housing further comprises a pneumatic port configured to couple to the pneumatic supply line; and
further comprising a first electromagnetic shield:
comprising a non-ferrous conductive coating extending across a first surface of the housing;
defining an array of opens configured to interrupt eddy-current loops within the non-ferrous conductive coating;
extending proximal and around the driveshaft aperture of the housing;
extending proximal and around the pneumatic port of the housing; and
configured to attenuate propagation of electromagnetic fields, generated by the set of hollow-core coil windings, beyond the housing, through the driveshaft aperture, and through the pneumatic port.

17. A system comprising:
a rotor:
configured to rotate about a rotor axis; and
comprising a set of coil windings configured to generate magnetic dipoles that interact with a magnetic field generated by a magnetic resonance imaging machine to rotate the rotor about the rotor axis;
a slip-ring assembly:
coaxial with the rotor axis;
extending into a center of the rotor; and
comprising a set of slip-rings configured to electrically couple to the set of coil windings;
a power transmission coupled to the rotor;
a housing:
containing the rotor, the slip-ring assembly, and the power transmission; and
defining a driveshaft aperture; and
a non-conductive driveshaft:
coupled to the power transmission;
extending through the driveshaft aperture of the housing; and
configured to output torque:
generated by the set of coil windings interacting with the magnetic field generated by the magnetic resonance imaging machine; and
transmitted from the rotor to the non-conductive driveshaft by the power transmission.

18. The system of claim 17:
wherein the power transmission comprises:
a wave-generator bearing coupled to the rotor and laterally adjacent the set of coil windings; and
a flexspline cup:
arranged about the wave-generator bearing; and
configured to rotate about the rotor axis;
wherein the housing comprises a circular-spline ring:
arranged about the flexspline cup and coaxial with the rotor; and
cooperating with the flexspline cup and coaxial with the rotor to form a strain-wave transmission;
wherein the non-conductive driveshaft is coupled to the flexspline cup; and
further comprising a shield:
comprising a non-ferrous conductive coating extending across a surface of the housing;
extending proximal and around the driveshaft aperture of the housing; and
configured to attenuate propagation of electromagnetic fields, generated by the set of hollow-core coil windings, beyond the housing and through the driveshaft aperture.

19. The system of claim 17:
further comprising:
a robotic arm base;
a robotic arm segment; and
an end effector;
wherein the rotor, the slip-ring assembly, the power transmission, the housing, and the non-conductive driveshaft form a first statorless gearhead motor:
interposed between the robotic arm base and the robotic arm segment; and
configured to drive the robotic arm segment over a first range of positions on the robotic arm base; and
further comprising a second statorless gearhead motor:
interposed between the robotic arm segment and the end effector; and
configured to drive the end effector over a second range of positions on the robotic arm segment.

20. A statorless gearhead motor comprising:
a rotor:
configured to rotate about a rotor axis; and
comprising a set of coil windings configured to generate magnetic dipoles that interact with a magnetic field generated by a magnetic resonance imaging machine to rotate the rotor about the rotor axis;
a slip-ring assembly:
coaxial with the rotor axis; and
configured to electrically couple to the set of coil windings;
a power transmission:
coupled to the rotor; and
configured to output torque:
generated by the set of coil windings interacting with the magnetic field generated by the magnetic resonance imaging machine; and
transmitted by the rotor into the power transmission; and
a non-ferrous shield:
arranged about the set of hollow-core coil windings; and
configured to attenuate propagation of electromagnetic fields, generated by the set of hollow-core coil windings, toward the magnetic resonance imaging machine.
